(19) United States
(12) Patent Application Publication
(10) Pub. No.: US 2009/0184283 A1
(43) Pub. Date: Jul. 23, 2009

(54) Antioxidants for phase change ability and thermal stability enhancement

(76) Inventors: Deborah Duen Ling Chung, E. Amherst, NY (US); Yasuhiro Aoyagi, Amherst, NY (US)

Correspondence Address: DEBORAH D.L. CHUNG, 108 ROLLING MEADOW, E. AMHERST, NY, 14051, US

(21) Appl. No.: 12/016,989

(22) Filed: Jan. 18, 2008

(51) Int. Cl. C09K 5/00

(52) U.S. Cl. 252/67

(57) ABSTRACT

Phase change ability and thermal stability enhancement have been attained by use of antioxidants and solid component. The phase change component consists essentially of secondary antioxidant (preferably with a minor proportion of primary antioxidant). Both said secondary antioxidant and said primary antioxidant are not dissolved in a liquid solvent. Thus, phase change materials exhibiting high heat of fusion, high thermal stability of the liquid (phase after melting), good phase change cyclability and melting temperature below about 50° C. are provided. By the combined use of the phase change component and second solid that remains a solid above the melting temperature of said phase change component, a phase change composite is provided. Said composite, wherein said second solid is dispersed in said phase change component, is effective for use as a thermal interface material for enhancing thermal contacts at use temperatures above the melting temperature of said phase change component. By using secondary and primary antioxidants, both dissolved in polyol ester liquid, in combination with dispersed solid (dispersed in said liquid) that enhances the thermal stability of said liquid, polyol-ester-based pastes that exhibit high thermal stability at temperatures up to at least 220° C. are provided. The secondary antioxidant, whether it is dissolved in a liquid solvent or not, is preferably thioether, most preferably thiopropionate. The primary antioxidant is preferably half-hindered phenolic. In case that antioxidants are dissolved in polyol ester liquid, the primary antioxidant and secondary antioxidant in combination preferably amount to less than 5% by weight of the liquid part of the polyol-ester-based paste. Both said second solid in said phase change composite and said dispersed solid in said paste are selected from the group: boron nitride, zinc oxide, alumina, carbon black, carbon fiber, carbon nanotube, graphite, diamond, silver, gold, aluminum and nickel.

### FIELD OF THE INVENTION

This invention relates to organic-based phase change materials and antioxidants, particularly for use as thermal interface materials.

### BACKGROUND OF THE INVENTION

Phase change ability refers to the ability of a composition to change its phase, e.g., from a solid to a liquid upon heating and from a liquid to a solid upon cooling. Although the change from a solid phase to another solid phase is also a phase change, phase changes that involve only solids tend to have low values of the heat of transformation compared to phase changes that involve a liquid.

Thermal stability refers to the stability or durability at an elevated temperature. It tends to be particularly inadequate for liquids, due to the tendency for the molecules in the liquid to evaporate. Thermal stability enhancement refers to the ability of a composition to enhance the thermal stability of itself and/or a host material in which the composition resides.

Phase change allows the absorption or evolution of latent heat. The heat absorbed during melting at the melting temperature is called the heat of fusion. The heat evolved during solidification at the solidification (freezing) temperature is called the heat of solidification. The heat absorption is useful for the storage of heat, while the heat evolution is useful for the release of heat. For example, heat is stored in a building in the warm part of a day, while heat is released in the cool part of a day for the purpose of energy conservation and thermal regulation.

Due to the high fluidity and conformability of the liquid compared to the corresponding solid, the liquid state is valuable for applications that require fluidity or conformability. Below the melting temperature, the composition is not conformable and cannot flow, whereas it is conformable and capable of flowing above the melting temperature. The phase change from solid to liquid (melting) allows the occurrence of the liquid to be controlled by the temperature. The suitable melting temperature depends on the particular application. For example, if conformability or fluidity is required above 40° C., the melting temperature should be at or below 40° C.

An example of an application of phase change is the use of the material as a temperature controlled valve. Below the melting temperature, the material is a solid and the valve is open. Above the melting temperature, the material is a liquid, which occupies more volume than the solid, and the valve is closed.

A phase change material (abbreviated PCM) is a material that undergoes a phase change upon heating or cooling. PCMs of the prior art include waxes (U.S. Pat. No. 6,764,759, U.S. Pat. No. 6,391,442, U.S. Pat. No. 6,956,739 and U.S. Pat. No. 6,835,453), C₁₂-C₁₆ alcohols, acids, esters, low molecular weight styrenes, methyl triphenyl silane materials (U.S. Pat. No. 6,764,759 and U.S. Pat. No. 6,391,442), polyethylene (U.S. Pat. No. 4,711,813), polyether fatty acid esters (US Patent Application 20060235151), polyols (Yasuhiro Aoyagi, Chia-Ken Leong and D. D. L. Chung, “Polyol-Based Phase-Change Thermal Interface Materials”, Journal of Electronic Materials 35(3), 416-424 (2006), which is hereby incorporated by reference in its entirety), ethylene-propylene copolymers (U.S. Pat. No. 6,956,739), and terpolymers (EPDM) of ethylene and propylene and a diene (U.S. Pat. No. 6,956,739).

For the purpose of improving the thermal stability of the PCM after melting, antioxidants may be used as minor additives (U.S. Pat. No. 6,689,837 and U.S. Pat. No. 6,689,466). An example is the antioxidant Irganox® 1010 (Ciba-Geigy Corp.), a phenolic antioxidant, in the amount of about 0.1% to 1.0% by weight (U.S. Pat. No. 6,689,837). Another example is a phenolic antioxidant in the amount ranging from 0.01% to 10% by weight (U.S. Pat. No. 6,689,466).

For essentially all applications involving PCMs, the phase change needs to be reversible, so that the thermal cycle of melting and subsequent solidification can be repeated many times (i.e., phase change cyclability). Moreover, the PCM needs to have low supercooling, i.e., the hysteresis of the melting-solidification process is small, so that the solidification temperature is not much below the melting temperature. Supercooling is mathematically defined as the temperature difference between phase change onset temperatures during heating and cooling for the same thermal cycle. Furthermore, the PCM needs to have adequate thermal stability and low reactivity. For applications related to heat storage, the PCM also needs to have a high heat of fusion. Inorganic PCMs such as salt hydrates tend to suffer from high reactivity, poor thermal stability and high supercooling. In contrast, organic PCMs such as wax tend to exhibit low reactivity, high thermal stability and low supercooling. In spite of the relatively high thermal stability, the thermal stability of wax is insufficient for long-term use. The choice of PCM for a particular application is further limited by the required range of phase change temperature.

Thermal stability is needed for high temperature lubricants, thermal greases and other applications that involve usage at elevated temperatures, i.e., temperatures above room temperature. The range of elevated temperatures depends on the particular application. For office electronics, the maximum elevated temperature is typically around 100° C. If the electronics are used under the hood of an automobile, the maximum temperature may reach 150° C. Jet engine lubricants require the ability to withstand sump temperatures approaching 200° C.

Mass loss upon heating means loss of material upon heating. It is detrimental to any application that involves the use of the materials at an elevated temperature.

Another undesirable thermal effect is the irreversible increase in viscosity of a liquid upon heating. This effect may be due to crosslinking of the organic molecules in the liquid. Crosslinking is a reaction that tends to occur upon heating. A high viscosity is not desirable for lubricants. It is also not desirable for the conformability of a thermal grease, although an increase in viscosity after the grease has already conformed may be acceptable. Nevertheless, the use of a thermal grease during temperature variation will be more reliable and simpler if the grease does not increase its viscosity upon heating.

A liquid does not crack, due to its fluidity. However, a paste or grease can crack upon heating. This is known as thermal cracking. For example, the partial loss of vehicle in a paste as the temperature increases can cause deprivation of the vehicle, and hence cracking of the paste.

Compared to metals and ceramics, organic compositions tend to be limited in thermal stability, due to their tendency to degrade chemically through reactions such as oxidation. For example, the reaction may cause the organic molecules to break up into smaller molecules. In general, small molecules evaporate more easily than large molecules. Evaporation means loss of material. As another example, the reaction may involve the decomposition of the organic molecules, thereby forming other types of molecules that may not exhibit the properties desired.

Due to the relative ease of evaporation of small molecules, large molecules are preferred for providing an organic medium of high thermal stability. An example of a relatively large molecule is paraffin wax (CₙH₂ₙ₊₂, 40>n>20), which is a hydrocarbon with a linear structure and a large number of carbon atoms.

Overheating is the most critical problem in the microelectronic industry, as it limits the further miniaturization, power and reliability. Enhancing the dissipation of heat from the microelectronic package requires not only a good heat sink or heat spreader (i.e., a material of high thermal conductivity for channeling the heat off to the surrounding). It also requires the thermal contact between the heat source (e.g., the microprocessor of a computer) and the heat sink or heat spreader to be good. A good thermal contact is a thermal contact that is associated with a low thermal resistance in the direction perpendicular to the contact area.

The compositions of this invention are particularly useful for thermal interface materials (abbreviated TIMs), which are materials applied to the interface between two proximate surfaces for improving thermal contact between these surfaces. The two surfaces may be, for example, the proximate surfaces of a microprocessor and a heat sink of a computer. Thermal interface materials in the form of pastes are called thermal pastes or thermal greases.

The use of PCMs as TIMs has been previously disclosed (Zongrong Liu and D. D. L. Chung, “Boron Nitride Particle Filled Paraffin Wax as a Phase-Change Thermal Interface Material”, Journal of Electronic Packaging 128(4), 319-323 (2006), which is hereby incorporated by reference in its entirety; Yasuhiro Aoyagi, Chia-Ken Leong and D. D. L. Chung, “Polyol-Based Phase-Change Thermal Interface Materials”, Journal of Electronic Materials 35(3), 416-424 (2006); U.S. Pat. No. 6,764,759; U.S. Pat. No. 6,391,442; U.S. Pat. No. 6,956,739). For application as TIMs, the organic PCMs are preferred to the inorganic ones, due to their low tendency for causing ionic contamination.

Conformability of the TIM to the proximate surfaces is critical to the effectiveness of the thermal interface material in improving the thermal contact between the two surfaces. Conformability tends to be associated with fluidity. Fluidity can cause seepage, particularly when the orientation of the computer is disturbed during transportation. Phase change ability allows the control of the temperature for the occurrence of fluidity and conformability, so that the thermal interface material is not fluid (or low in fluidity) at room temperature and becomes fluid (or high in fluidity, and hence conformable) at the elevated use temperature (Zongrong Liu and D. D. L. Chung, “Boron Nitride Particle Filled Paraffin Wax as a Phase-Change Thermal Interface Material”, Journal of Electronic Packaging 128(4), 319-323 (2006); U.S. Pat. No. 6,956,739). For thermal interface materials used in microelectronics, the PCM melting temperature should be quite low, for example, below 50° C. The use temperature depends on the particular electronic application. The absorption of the heat of fusion during melting of the PCM provides an additional mechanism of heat removal from the microelectronics, so a high heat of fusion is preferred.

Thermal degradation of a TIM may cause the material to harden and become less conformable, thus decreasing the effectiveness of the TIM. It may also cause the partial loss of the TIM after the paste has been installed, thus resulting in air voids (which are not conductive thermally) in the TIM or gaps at the interface between the TIM and either of the proximate surfaces. As air is a thermal insulator, voids and gaps are detrimental to the effectiveness of a TIM. Furthermore, thermal degradation may cause delamination, i.e., separation of the TIM from one or both of the proximate surfaces. Since computer users usually do not change the TIMs until the computer has developed a problem, the thermal stability is practically important. Due to the requirements of thermally stable phase change characteristics, the attainment of high thermal stability for a TIM in the form of a PCM tends to be more challenging than that for a TIM that is not in the form of a PCM.

The thermal conductivity of a PCM can be increased by using a filler (particles, fibers, etc.) that is thermally conductive. Examples of particulate fillers are boron nitride, titanium diboride, aluminum nitride, silicon carbide, graphite, metals and metal oxides (U.S. Pat. No. 6,956,739). Hence, the PCM becomes the matrix of a composite material. An example of a composite material is a material with wax (a PCM) as the matrix and hexagonal boron nitride particles as the filler (Zongrong Liu and D. D. L. Chung, “Boron Nitride Particle Filled Paraffin Wax as a Phase-Change Thermal Interface Material”, Journal of Electronic Packaging 128(4), 319-323 (2006)). Hexagonal boron nitride refers to boron nitride with a crystal structure that is hexagonal. The filler does not melt, but its presence can affect the phase change characteristics, including the melting temperature and the heat of fusion. Due to the low thermal conductivity of the organic PCMs compared to inorganic ones, the use of a thermally conductive filler is important.

In order to diminish excessive fluidity resulting from the melting of a PCM, a PCM can be used in combination with a component (e.g., a polymer, as disclosed in U.S. Pat. No. 6,764,759 and U.S. Pat. No. 6,391,442) that itself remains in a state of low fluidity above the melting temperature of the PCM.

Polyol ester is an organic liquid that is relatively high in its degree of thermal stability, so it is used as a high temperature lubricant, as the vehicle (host material) in thermal pastes for improving thermal contacts, and in other applications that require a liquid that can withstand elevated temperatures.

Oxidation is a chemical reaction that transfers electrons from a substance to an oxidizing agent. A radical is an atomic or molecular species with unpaired electrons. Each unpaired electron is conventionally represented by a dot in the chemical formula for the radical. Due to the reactivity of these unpaired electrons, radicals (or free radicals) are likely to take part in chemical reactions. Oxidation reactions can produce radicals, which start chain reactions that are detrimental to the molecules.

Antioxidants are molecules (i.e., additives) that inhibit the oxidation of molecules, which include themselves and other molecules (e.g., the molecules of a lubricant, the oxidation resistance of which is to be enhanced). Antioxidants terminate these chain reactions by removing radical intermediates. In addition, antioxidants inhibit other oxidation reactions by being oxidized themselves. As a result, antioxidants are often reducing agents such as thiols and thioethers. A thiol is a compound that contains the functional group composed of a sulfur atom and a hydrogen atom (—SH). A thioether is a functional group that has the structure R¹—S—R² as shown below.

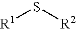

A thioether is similar to an ether, except that it contains a sulfur atom in place of the oxygen. Thiopropionate is a type of thioether.

Antioxidants are classified into primary and secondary antioxidants. Combined use of a primary antioxidant and a secondary antioxidant provides a synergistic effect. By using more than one antioxidant, multiple mechanisms act synergistically to raise the thermal stability to levels above what can be attained by using a single antioxidant.

Phenolics (sometimes known as phenols) are a class of compounds that consist of a hydroxyl group (—OH) attached to an aromatic hydrocarbon group. The simplest of this class of compounds is phenol (C₆H₅OH), which is

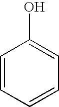

The hydroxyl group in a phenolic is not bonded to a saturated carbon atom. Due to the aromatic ring tightly coupling with the oxygen and a relatively loose bond between the oxygen and hydrogen, phenolics have relative high acidities.

A steric effect stems from the fact that each atom in a molecule occupies a certain volume. When atoms are brought too close together, the energy increases due to overlapping electron clouds, thereby possibly affecting the reactivity and conformation of the molecule. Steric hindrance (also known as steric resistance) is a type of steric effect in which the size of groups in a molecule prevents chemical reactions that are observed in related smaller molecules.

An amine is an organic compound that contains nitrogen as the key atom. The molecular structure of an amine resembles that of ammonia, wherein one or more hydrogen atoms are replaced by organic substituents such as alkyl and aryl groups. The general structure of an amine is shown below.

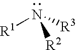

Aryl refers to a functional group or a substituent derived from a simple aromatic ring. The simplest aryl group is phenyl, C₆H₅. Other examples are benzyl, tolyl and o-xylyl. The molecular structure of these four examples is shown below.

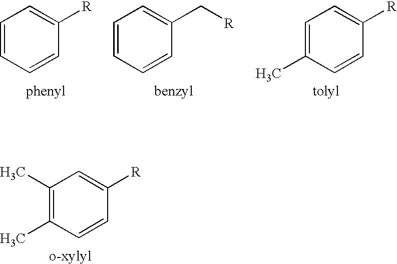

Primary antioxidants include hindered phenolic and aryl amine compounds. The hindrance in connection with a hindered phenolic compound refers to steric hindrance. For example, steric hindrance occurs when the t-butyl group in a molecule prevents the radical in polyol ester from being close to the OH group of the antioxidant.

Phenolic compounds have active OH groups, whereas amine compounds have active NH or NR (where R is a side group) groups. A half-hindered phenolic compound (also called a partially hindered phenolic compound) refers to a phenolic compound in which a large side group occurs on one side of the OH group in the phenolic molecule. An example of a half-hindered phenolic primary antioxidant is

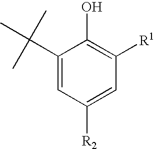

where the bulky tert-butyl (or C(CH₃)₃) group on the left side of the OH group hinders the approach to the OH group by other molecules, and common R¹ is either hydrogen or methyl group.

A fully-hindered phenolic compound refers to a phenolic compound in which a large side group occurs on each of the two sides of the OH group in the phenolic molecule. An example of a fully-hindered phenolic primary antioxidant is

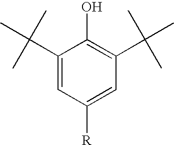

where the bulky tert-butyl groups on both sides of the OH group hinder the approach to the OH group more than the case of a half-hindered phenolic compound. The steric hindrance due to this tert-butyl group makes the molecular interaction between primary antioxidant and secondary antioxidant more difficult. On the other hand, the radical stability of a fully-hindered phenolic antioxidant is higher than that of a half-hindered phenolic antioxidant.

Phenolic stabilizers are primary antioxidants that act as hydrogen donors. Peroxy radicals are HOO^{•} and its organic homologues ROO^{•}. Phenolic stabilizers react with peroxy radicals to form hydroperoxides and prevent the abstraction of hydrogen from the polymer backbone. The ROO^{•} radicals are deactivated by hindered phenol via reactions such as the following reaction.

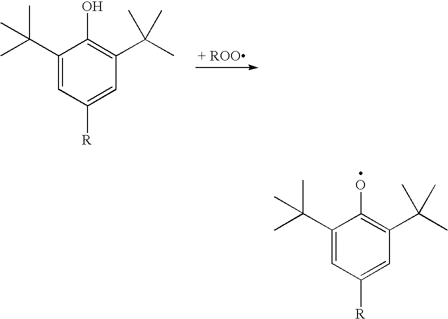

In general, a peroxy radical reacts with a primary antioxidant (abbreviated as AH), thereby terminating the free radical chain reaction, as shown by Eq. (1).

ROO^{•}+AH→ROOH+A^{•} (1)

The A^{•} radical is stable, thus preventing thermal oxidative degradation.

A secondary antioxidant reduces an active hydroperoxide, ROOH in Eq. (1), to an inactive alcohol, ROH. Secondary antioxidants include phosphorous and thiopropionates. An example of a thiopropionate type secondary antioxidant is

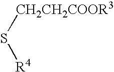

It functions through the reaction

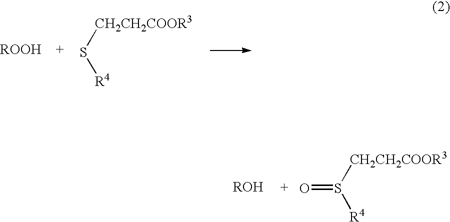

Aryl amines also act as primary antioxidants and are excellent hydrogen donors. The mechanism involved in the reaction is illustrated below.

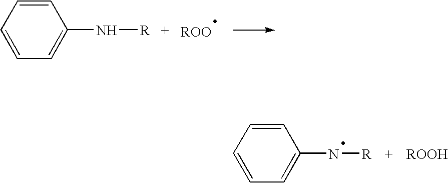

Secondary antioxidants, frequently referred to as hydroperoxide (ROOH) decomposers, decompose hydroperoxides into non-radical, non-reactive, and thermally stable products. They are often used in combination with primary antioxidants to yield synergistic stabilization effects.

A paste is a liquid containing one or more solid components (usually in the form of fine particles) that are dispersed and suspended in the liquid. The solid components may serve various functions, such as increasing the thermal conductivity, increasing the viscosity, increasing the ability of the paste to suspend another solid component in the paste, serving as a solid lubricant, etc.

The liquid in a paste is known as the vehicle. It is the host material. When the particle size is sufficiently small and the particles are well dispersed, a paste is smooth to the touch and is often referred to as a grease. The pastes addressed in this invention are also greases.

Liquids and pastes that can withstand elevated temperatures are needed for numerous applications, such as crank case lubricants, transmission fluids, gear lubricants, gas turbine lubricants, jet engine lubricants, stationary turbine engine lubricants, lubricating oils, refrigeration lubricants, industrial oven chains, high temperature greases, fire resistant transformer coolants, fire resistant hydraulic fluids, textile lubricants, compressor bearing lubricants, passenger car motor oils, and greases for operating at elevated temperatures.

The surface of a heat source or a heat sink is never perfectly smooth. The air pockets (however small) between the proximate surfaces decrease the heat flow, since air is a thermal insulator. A good thermal contact, as enabled by the use of an effective TIM, is necessary for heat to flow effectively from the heat source to the heat sink. An effective TIM must be conformable to the surface topography of the proximate surfaces, so that it displaces the air from the interface. In addition, an effective TIM should be thermally conductive. The thermal conductivity of the TIM is made possible by the solid component in the paste, since the liquid component (the vehicle) is not (or essentially not) conductive. Hence, the solid component of a TIM is preferably a solid that is thermally conductive. Examples of such solid components include ceramics (e.g., boron nitride, zinc oxide, etc.), carbons (carbon black, carbon fiber, carbon nanotube, graphite, diamond, etc.) and metals (e.g., silver, gold, aluminum, nickel, etc.).

A polyol ester is a synthetic high temperature reaction product of an organic fatty acid with a polyhydric alcohol. An example is neopentyl polyol ester, which is made by reacting a monobasic fatty acid with a polyhedric alcohol with a neopentyl structure. Compared to other synthetic lubricants, such as diesters and polyalphaolefins, polyol esters are superior in the thermal stability. The superior thermal stability of polyol esters over diesters stems from the larger number (e.g., 6) of ester groups in a polyol ester and the consequent increased polarity and reduction in volatility.

An alternate vehicle for thermal pastes is silicone. However, silicone suffers from its tendency to migrate and separate. Separation refers to the agglomeration of the solid component so that the solid component is no longer dispersed in the vehicle.

Polyol ester degrades and becomes higher in viscosity at elevated temperatures. The thermal degradation in air is mainly due to the oxidation of polyol ester. The oxidation causes chain scission and the formation of radicals. The chain scission results in small molecules, which tend to evaporate easily. The reactivity of the radicals can cause the linking of molecules, thus resulting in long molecules, which increase the viscosity. In the presence of an antioxidant, the radicals are changed to stable ROOR′ and ROOH. As a consequence, the antioxidants enhance the thermal stability.

Antioxidants have long been used in organic host materials to increase the thermal stability of the host. Due to the difference in chemistry among host materials, the mechanism of thermal instability differs. As a consequence, the choice of antioxidants and their amounts depends on the host material.

In the case of polyol ester as the organic material, the following antioxidants have been recommended in the prior art. Kendall (US Patent Application 20070031686) recommended a single antioxidant, namely IRGANOX 1010 (a fully-hindered phenolic compound, a primary antioxidant from Ciba Specialty Chemicals, Tarrytown, N.Y.). Khatri (U.S. Pat. No. 6,900,163) recommended a single antioxidant, namely ETHANOX 330 (a fully-hindered phenolic compound, a primary antioxidant from Albemarle Corp., Baton Rouge, La.) in the amount of 1 wt. %. Sunaga et al. (U.S. Pat. No. 5,369,287) recommended a fully-hindered phenolic antioxidant, a primary antioxidant, in the amount ranging from 0.01 to 0.30 wt. %. Markson et al. (U.S. Pat. No. 6,048,825) recommended a hindered phenolic antioxidant, a primary antioxidant, such as butylated hydroxytoluene (without indication of whether the fully-hindered or half-hindered kind of this molecule is preferred) in the amount of 0.01 to 5 wt. %. Otake et al. (U.S. Pat. No. 5,405,543) recommended a secondary aromatic amine antioxidant, a primary antioxidant. In the prior art, there is no mention of half-hindered phenolic compounds for serving as antioxidants for polyol ester.

In the case of a general type of polyolefin (of which polyol ester is a type) as the organic material, the combined used of one primary antioxidant in the form of a hindered phenolic compound (with no teaching on the preferred type of hindered phenolic compound, i.e., whether fully-hindered or a half-hindered) in the amount of 0.01-0.5 wt. %, a first secondary antioxidant in the form of a phosphorous compound in the amount of 0.01-0.5 wt. %, and a second secondary antioxidant in the form of a sulphur-containing compound in the amount of 0.01-1.0 wt. % is recommended by Oysaed et al. (US Patent Application 2006122295).

For the case of a general type of oil as the organic vehicle in the absence of a solid component, the closest prior art (Migdal and Sikora, US Patent Application 20050170978) uses a primary antioxidant in the form of a general type of hindered phenolic compound (with no teaching on the preferred type of hindered phenolic compound, i.e., whether fully-hindered or half-hindered phenolic) and a secondary antioxidant in the form of a thioether, such as a thiopropionate.

In the case of silicone as the organic material, a single phenolic antioxidant in the amount from 0.001 to 1 wt. % was recommended by Feng et al. (U.S. Pat. No. 6,620,515 and U.S. Pat. No. 7,074,490). In the case of polyethylene (a polyolefin) as the organic material, a primary antioxidant that is either a fully hindered or half-hindered phenolic (but preferably fully hindered for greater thermal stability) in the amount from 0 to 0.083 wt. %, a secondary antioxidant that is of the phosphorous type and is in the amount from 0 to 0.083 wt. %, and carbon black in the amount from 0 to 0.83 wt. %, were used by J. M. Pena, N. S. Allen, M. Edge, C. M. Liauw and B. Valange (Polymer Degradation and Stability 72 (2001) 163-174, which is hereby incorporated by reference in its entirety).

In case of polypropylene (a polyolefin) as the organic material, a half-hindered phenolic is used by Ishii et al. as the primary antioxidant in the amount from 0.01 to 1 wt. % (U.S. Pat. No. 5,250,593).

In case of a mixture of mineral oil and synthetic oil as the organic material, a fatty acid ester is used by Yoshida et al. as the single antioxidant in the amount from 0.1 to 5 wt. % (U.S. Pat. No. 5,658,865).

The choice of antioxidants in most of the commercial products, including TIMs, is proprietary and the scientific reason behind the choice of antioxidants that are not proprietary is usually not stated.

One of the solid components used in the polyol-ester-based pastes of the prior art is carbon black, which is thermally conductive. The outstanding effectiveness of such pastes as thermal pastes has been previously shown (Chung, US Patent Application 20060246276), but no antioxidant was used in this prior work. The effectiveness of carbon black in thermal pastes is due to its high conformability, which stems from its microstructure consisting of porous agglomerates of nanoparticles that are essentially spherical.

Carbon black is widely used as a black pigment in paints, the thermal stability of which is also of concern. Thus, this invention is also useful for paints and coatings that can withstand elevated temperatures.

Carbon black is produced either by incomplete combustion or thermal decomposition of a hydrocarbon feedstock. Types of carbon black include soot, lamp black (typical particle size 50-100 nm), channel black (typical particle size 10-30 nm), furnace black (typical particle size 10-80 nm), thermal black (typical particle size 150-500 nm), and acetylene black (typical particle size 35-70 nm).

Another solid component used in pastes of the prior art is hexagonal boron nitride (i.e., BN), which is thermally conductive, yet electrically insulating. Hexagonal boron

The combination of thermal conductivity and electrical nonconductivity makes boron nitride particularly attractive for thermal pastes that are used in electronic packages (C.-K. Leong, Y. Aoyagi and D. D. L. Chung, Journal of Electronic Materials 34 (2005) 1336-1341, which is hereby incorporated by reference in its entirety); no antioxidant was used in this prior art. Electrical insulation is desirable for most thermal pastes, for fear that the paste may seep out of the thermal interface and cause electrical short-circuiting. In addition, due to its lamellar structure, hexagonal boron nitride can serve as a solid lubricant, so it is used as a lubricant additive. However, boron nitride particles are much larger than carbon black particles. Small particles are desirable for effective filling of the valleys in the topography of the proximate surfaces. In other words, small particles are desirable for enhancing the conformability of the thermal paste.

The present invention is directed to overcoming these and other deficiencies in the art.

### SUMMARY OF THE INVENTION

This invention relates to compositions comprising one or more antioxidants for (i) providing to an organic solid the ability to change its phase from a solid to a liquid, wherein the phase change (melting) is characterized by high heat of fusion, sufficiently low supercooling and phase change cyclability, and (ii) enhancement of the thermal stability of an organic liquid, which includes the liquid that results from said phase change.

This invention provides compositions of high thermal stability at temperatures up to at least 220° C., as attained by synergistic use of substances selected from the group: polyol ester, secondary antioxidant, primary antioxidant and the solid component.

In case that polyol ester is included in the composition, minor proportions of secondary and primary antioxidants are dissolved in the polyol ester liquid and an appropriate solid component is dispersed in the liquid for the purpose of increasing the thermal stability of the liquid, particularly at temperatures below 180° C. This composition gives a high degree of thermal stability to the liquid. The secondary antioxidant is preferably a thioether, most preferably a thiopropionate. The primary antioxidant is preferably a hindered phenolic, most preferably a half-hindered (also called partially hindered) phenolic. The use of a primary antioxidant in the form of a fully-hindered phenolic is less effective than the use of a primary antioxidant in the form of a half-hindered phenolic. The total antioxidant amount is up to 5 wt. % of the polyol ester liquid, preferably ranging from 0.5 wt. % to 1.5 wt. %. The most preferred value is 1.5 wt. %. The primary antioxidant is used in a smaller amount by weight than the secondary antioxidant. A preferred weight ratio of primary antioxidant to secondary antioxidant is 1:2. The most preferred antioxidant amount is that the total antioxidant content is 1.5 wt. % of the polyol ester(s) and the weight ratio of primary antioxidant to secondary antioxidant is 1:2. The use of a solid component to enhance the thermal stability of polyol ester has not been previously disclosed and is an important part of this invention. The solid component is dispersed in the liquid medium; it preferably amounts to 1-60 vol. % of the sum of the volume of the liquid and the volume of the solid. Examples of effective solid components are boron nitride, aluminum nitride, carbon black, carbon fiber, carbon nanotube, graphite, diamond, alumina (also known as aluminum oxide), zinc oxide, aluminum, nickel, silver, gold. Boron nitride is particularly effective for enhancing the thermal stability of the liquid when it is in the presence of appropriate primary and secondary antioxidants, particularly below 180° C. In addition, boron nitride is attractive in its thermal conductivity. Thus, a paste exhibiting high thermal stability, sufficiently low viscosity at an elevated temperature, low tendency for thermal cracking and high effectiveness as an interface paste for improving thermal contacts is provided by this invention.

In case that liquid solvents (e.g., polyol ester) of the selected antioxidants are not included in the composition, a secondary antioxidant (optionally together with a minor proportion of a primary antioxidant, with the weight ratio of the secondary antioxidant to the primary antioxidant preferably ranging from 5 to 100) that melts at an appropriate temperature is used in contact with and in combination with an appropriate solid component which remains in solid state above the melting temperature of the secondary antioxidant. Said secondary antioxidant is a solid below its melting temperature. The notion that said secondary antioxidant is a solid implies that it is not dissolved in a liquid solvent. The secondary antioxidant is preferably a thioether, most preferably a thiopropionate. The primary antioxidant is preferably a hindered phenolic, most preferably a half-hindered phenolic. Examples of solid components are boron nitride, aluminum nitride, carbon black, carbon fiber, carbon nanotube, graphite, diamond, alumina, zinc oxide, nickel, silver and gold. Boron nitride is most preferred. This composition gives a PCM that exhibits high thermal stability of the molten phase (phase after melting), high heat of fusion, sufficiently low supercooling and good phase change cyclability.

That a secondary antioxidant rather than a primary antioxidant is the dominant phase change component in the PCM of this invention is because the phenolic molecular structure of the primary antioxidant causes large supercooling. In contrast, the secondary antioxidant gives melting temperature below 50° C. and gives small supercooling. Nevertheless, a primary antioxidant may be used as a minor component along with the secondary antioxidant in order to enhance the thermal stability of the liquid (the phase after melting). The weight ratio of the secondary antioxidant to the primary antioxidant preferably ranges from 5 to 100. Said secondary and primary antioxidants constitute a single phase that is based on the secondary antioxidant. In other words, the secondary and primary antioxidants are not distinct phases. Thus, the melting temperature of said single phase is governed by

In case that liquid solvents (e.g., polyol ester) of the selected antioxidants are not included in the composition, the PCM mainly in the form of a secondary antioxidant can serve as the matrix of a composite TIM that contains a filler in the form of a solid dispersed in the composite, such that the filler remains in solid state at temperatures above the melting temperature of the PCM. The composite is an effective TIM at use temperatures above the melting temperature of the PCM, because the molten PCM matrix allows the TIM composite to conform to the topography of the proximate surfaces that constitute the thermal contact to be enhanced. This means that the melting temperature of the PCM needs to be suitable for the TIM to serve at use temperatures associated with the particular application. For electronic applications, a melting temperature below about 50° C. is suitable. The filler is advantageous in that it limits the fluidity of the composite material above the melting temperature of the PCM. In numerous applications, excessive fluidity can cause undesirable migration of the material in the vicinity of the material in the application environment. The filler preferably amounts to 1-60 vol. % of the composite. Examples of fillers are boron nitride, aluminum nitride, carbon black, carbon fiber, carbon nanotube, graphite, diamond, alumina, zinc oxide, aluminum, nickel, silver, gold. Boron nitride is most preferred. In addition, boron nitride is attractive in its thermal conductivity, as it enhances the thermal conductivity of the phase change composite both below and above the melting temperature of the phase change component. A phase change composite that is thermally conductive both below and above the melting temperature of the phase change component is advantageous for numerous thermal applications. Furthermore, a phase change composite that is not too fluid above the melting temperature is advantageous for numerous applications.

This invention provides a thermal contact enhancing interface material that comprises a first solid and a second solid, wherein said second solid remains in solid state at use temperatures above the melting temperature of said first solid. Said first solid consists of secondary antioxidant, optionally along with primary antioxidant in a small proportion. The weight ratio of the secondary antioxidant to the primary antioxidant preferably ranges from 5 to 100. Said secondary and primary antioxidants constitute a single phase that is based on the secondary antioxidant. In other words, the secondary and primary antioxidants are not distinct phases. Thus, the melting temperature of said single phase is governed by that of the secondary antioxidant. The notion that said first solid is a solid implies that the antioxidant is not dissolved in a liquid solvent. The secondary antioxidant is preferably a thioether, most preferably a thiopropionate. The primary antioxidant is preferably a hindered phenolic, most preferably a half-hindered phenolic. The composition, upon contact with and positioned between two solid surfaces, forms a material that enhances the thermal contact between said surfaces at use temperatures above the melting temperature of said first solid.

### BRIEF DESCRIPTION OF THE DRAWINGS

FIG. 1 is a schematic representation of the experimental set-up for the guarded hot plate method of thermal contact conductance measurement. T₁, T₂, T₃ and T₄ are holes of diameter 3.3 mm. A resistance temperature detector (RTD) is inserted in each hole. All dimensions are in mm.

FIG. 2 is a graphic representation of the variation with the isothermal heating time of the remaining weight of polyol ester excluding antioxidants. The heating temperature is different for each of the three curves (a: 120° C., b: 160° C., c: 200° C.).

FIG. 3 is a graphic representation of the variation with the isothermal heating time of the remaining weight of polyol ester including 0.500 wt. % of SUMILIZER GA 80 and 1.000 wt. % of SUMILIZER TP-D. The heating temperature is different for each of the three curves (a: 160° C., b: 181° C., c: 199° C.).

FIG. 4 is a schematic representation of the functional groups that may work as an antioxidant on the edge sites of carbon black.

FIG. 5 is a schematic representation of a possible example of the resonance effect at the edge site of carbon black.

FIG. 6 is a schematic representation of a functional group (NH) that may work as an antioxidant on the edge plane of boron nitride.

FIG. 7 is a graphic representation of the variation of ln τ with the reciprocal absolute temperature, where τ is the time for 3% weight loss. The straight line fitted to the data points is extrapolated to a temperature of 100° C. in order to determine the 100° C. lifetime indicator. : No additive (HATCOL 2372), ∘: With antioxidants (HATCOL 2372 with 0.500 wt. % of SUMILIZER GA80 and 1.000 wt. % of SUMILIZER TP-D), □: Boron nitride paste including 0.500 wt. % of SUMILIZER GA 80 and 1.000 wt. % of SUMILIZER TP-D, ▴: Carbon black paste including 0.500 wt. % of SUMILIZER GA 80 and 1.000 wt. % of SUMILIZER TP-D.

FIG. 8 is a graphic representation of the variation of ln τ with the reciprocal absolute temperature, where τ is the time for 3% weight loss. The straight line fitted to the data points is extrapolated to a temperature of 100° C. in order to determine the 100° C. lifetime indicator. Antioxidants (HATCOL 2372 with 0.500 wt. % of SUMILIZER GA80 and 1.000 wt. % of SUMILIZER TP-D) are used. : Fumed alumina paste, □: Boron nitride paste, ▴: Carbon black paste, ⋄: Fumed zinc oxide.

FIG. 9 is a graphic representation of the variation of ln τ with the reciprocal absolute temperature, where τ is the time for 3% weight loss. The straight line fitted to the data points is extrapolated to a temperature of 100° C. in order to determine the 100° C. lifetime indicator. □: Boron nitride paste including 0.500 wt. % of SUMILIZER GA 80 and 1.000 wt. % of SUMILIZER TP-D, X: commercial polyol-ester-based silver paste (Arctic Silver® 5).

FIG. 10 is a graphic representation of the variation of the viscosity with the isothermal heating time at 200° C. for polyol ester without () or with (∘) the antioxidants 0.500 wt. % of SUMILIZER GA80 and 1.000 wt. %. SUMILIZER TP-D.

FIG. 11 is a schematic representation of the bond-line thickness measurement method.

FIG. 12 is a graphic representation of the variation of ln τ with the reciprocal absolute temperature, where τ is the time for 3% weight loss. The straight line fitted to the data points is extrapolated to a temperature of 100° C. in order to determine the 100° C. lifetime indicator. : 2.0 wt. % GA 80 and 98.0 wt. % TP-D with 16 vol. % boron nitride, ◯: 2.0 wt. % GA 80 and 98.0 wt. % TP-D, ▴: 2.0 wt. % GA 80 and 98.0 wt. % TPM with 16 vol. % boron nitride, ♦: Commercial PCM (T pcm 583), [symbol] : Commercial PCM (T pcm HP 105).

FIG. 13 is a graphic representation of thermal stability of variation with isothermal heating at 160±2° C. Solid thin line: 2.0 wt. % GA 80 and 98.0 wt. % TP-D with 16 vol. % boron nitride. Solid thick line: 2.0 wt. % GA 80 and 98.0 wt. % TPM with 16 vol. % boron nitride.

FIG. 14 is a graphic representation of DSC thermograms during heating and subsequent cooling for the antioxidant-based (2.0 wt. % of GA 80, 98.0 wt. % of TP-D) PCM without prior heating. Thin line: with boron nitride (16 vol. %). Bold line: without a solid component.

FIG. 15 is a graphic representation of DSC thermograms during heating and subsequent cooling for the antioxidant-based (2.0 wt. % of GA 80, 98.0 wt. % of TP-D) boron nitride (16 vol. %) PCM. Thin line: after heating at 150° C. for 24 h. Bold line: before heating.

FIG. 16 is a graphic representation of DSC thermograms during heating and subsequent cooling for a commercial PCM (FSF52). The scales are the same as those in FIG. 15. Thin line: after heating at 150° C. for 24 h. Bold line: before heating.

### DETAILED DESCRIPTION OF THE INVENTION

The first technological objective of this invention is to provide a PCM with a melting temperature below around 50° C. (as such a melting temperature is relevant to use of the PCM for microelectronic cooling), high heat of fusion, high thermal stability of the liquid resulting from the melting of the PCM, and good phase change cyclability.

The second technological objective of this invention is to improve the thermal stability of polyol-ester-based pastes in relation to reducing the extent of mass loss upon heating.

The third technological objective of this invention is to improve the thermal stability of polyol-ester-based pastes in relation to reducing the extent of viscosity increase upon heating.

The fourth technological objective of this invention is to improve the thermal stability of polyol-ester-based pastes in relation to reducing the tendency for thermal cracking.

The fifth technological objective of this invention is to attain improved thermal interface materials in forms that involve PCMs and in forms that do not involve PCMs, as needed for microelectronic cooling and other applications.

All the technological objectives mentioned above are attained in this invention by synergistic use of primary antioxidant, secondary antioxidant and solid component. Synergism among these three components has not been previously considered. In particular, the use of an antioxidant as the phase change component of a PCM has not been previously disclosed.

The science behind the use of antioxidants is complex, not only because of the variety of antioxidants, but also because of the interactions among the antioxidants, organic host (e.g., polyol esters) and solid component(s). This invention advances the state of the art in the use of antioxidants for improving the thermal stability of polyol-ester-based pastes. By reacting with the host molecules, an antioxidant renders improved oxidation resistance to the host.

This invention provides polyol-ester-based pastes of even higher degrees of thermal stability than the state of the art. The improvement in thermal stability is attained in this invention by the synergistic use of primary antioxidant, secondary antioxidant and solid component. The antioxidants are dissolved in the polyol ester liquid, but the solid component does not dissolve in the polyol ester liquid. Although the synergistic use of primary and secondary antioxidants is in the prior art, synergistic use of primary antioxidant, secondary antioxidant and solid component has not been previously disclosed. A particularly novel aspect of this invention relates to the use of a solid component to enhance the thermal stability of a liquid that is in contact with the solid component.

This invention provides for the first time a phase change component in the form of antioxidant. By reacting with radicals formed by the degradation of an antioxidant, an antioxidant improves its own thermal stability. The ability of an antioxidant to improve its own thermal stability is particularly valuable for enhancing the thermal stability of the molten form of the antioxidant (with the antioxidant being not dissolved in a liquid solvent, such as polyol ester), as needed for the use of the antioxidant as a PCM.

Jet engine lubricants require the ability to withstand sump temperatures approaching 200° C. TIMs for microelectronic cooling require the ability to withstand temperatures as high as 150° C. Thus, the elevated temperatures addressed in this invention include temperatures up to at least 220° C.

The highest service temperature for a liquid (which can be a part of a paste) depends on the requirement of the particular application. For example, a 3% weight loss of a liquid or paste may be acceptable for one application, but may be unacceptable for another application. Also for example, the highest service temperature for a liquid or paste may be 200° C. for one application, but 150° C. for another application. The service lifetime at a specified temperature for a liquid or paste also depends on the requirement of the particular application. For example, a service lifetime at 100° C. of 500 hours may be acceptable for one application, but may be in adequate for another application. A goal of this invention is to improve the thermal stability of the liquid or paste, so that the highest service temperature or the service lifetime at a specified temperature is increased, for the benefit of any of the applications.

The present invention provides polyol-ester-based pastes of high thermal stability at temperatures up to at least 220° C. The high thermal stability is associated with a low percentage loss in mass at elevated temperatures, the essential absence of viscosity increase as the temperature increases, and the essential absence of tendency for cracking at elevated temperatures. These attributes are valuable for the use of the pastes as thermal pastes for improving thermal contacts.

The high thermal stability mentioned in the last paragraph is attained by synergistic use of a primary antioxidant, a secondary antioxidant and a solid component in a polyol-ester-based paste. The antioxidants are dissolved in the polyol ester, but the solid component does not dissolve in the polyol ester. The antioxidants essentially do not affect the thermal contact conductance measured across mating surfaces that sandwich the paste.

The secondary antioxidant is preferably a thioether, more preferably a thiopropionate. The primary antioxidant is preferably in the form of a half-hindered phenolic. The use of a primary antioxidant in the form of a fully-hindered phenolic is less effective than the use of a primary antioxidant in the form of a half-hindered phenolic.

In the case that polyol ester is not present, the total antioxidant content is up to 5 wt. % of the liquid, preferably ranging from 0.5 wt. % to 1.5 wt. %. The most preferred value is 1.5 wt. %. The primary antioxidant is used in a smaller proportion than the secondary antioxidant. A preferred amount by weight of primary antioxidant ranges from 0.25 to 0.75 of that of the secondary antioxidant. The most preferred amount by weight of primary antioxidant is 0.50 of that of the secondary antioxidant. The most preferred antioxidant proportion is that the total antioxidant content is 1.5 wt. % of the vehicle and the amount by weight of primary antioxidant is 0.50 of that of the secondary antioxidant.

In the case that polyol ester is present, the combination of appropriate primary and secondary antioxidants causes the residual weight (excluding the solid component) after oven aging at 200° C. for 24 h (h=hours) to increase from 36 to 97 wt. %. They also cause the viscosity not to increase upon heating, in addition to reducing the tendency for thermal cracking. They essentially do not affect the thermal contact conductance measured across mating surfaces that sandwich the paste.

In the case that polyol ester is present, by using appropriate primary and secondary antioxidants in conjunction with a solid component, a paste exhibiting high thermal stability, sufficiently low viscosity at an elevated temperature, low tendency for thermal cracking and high effectiveness as an interface paste for improving thermal contacts is provided. The solid component is preferably selected from the group: boron nitride, zinc oxide, alumina, carbon black, carbon fiber, carbon nanotube, graphite, silver, aluminum and nickel. Boron nitride, zinc oxide and alumina are particularly attractive, due to their combination of thermal conductivity and electrical nonconductivity. In contrast, carbon black, carbon fiber, carbon nanotube, graphite, silver, gold, aluminum and nickel are both thermally and electrically conductive. Electrical nonconductivity is desirable for pastes that are used for improving thermal contacts in electronics, because seepage of the paste from the thermal contact to other parts of the electronic package may cause short-circuiting in case that the paste is electrically conductive. Below 180° C. and in the presence of primary and secondary antioxidants, hexagonal boron nitride as the solid component is effective for reducing the weight loss of the vehicle upon heating.

Thermal stability evaluation is conducted separately for compositions involving different solids, which include carbon black, boron nitride, aluminum nitride, fumed zinc oxide (with silane coating) and fumed alumina as the solid component. In case that a solvent (e.g., polyol ester) for antioxidant is not present, the antioxidant (a PCM) is a solid below its melting temperature. In contrast, each of the solids listed in this paragraph does not undergo melting while the PCM melts. Furthermore, evaluation is conducted both in the absence and in the presence of a solid component (chosen from the list of solids in this paragraph), in order to understand better the effect of the solid component on the antioxidation function.

Based on a lifetime corresponding to 3% weight loss, polyol-ester-based paste with boron nitride as the solid component shows an estimated lifetime of 19 years at 100° C., compared to 3.4 years for polyol-ester-based paste with fumed zinc oxide (with silane coating) as the solid component, 1.5 years for polyol-ester-based paste with fumed alumina as the solid component, 1.3 years for polyol-ester-based paste with carbon black as the solid component, 0.77 year for polyol ester liquid (with antioxidants and without a solid component), 0.010 year for a commercial polyol-ester-based paste with silver as the solid component (Arctic Silver 5, Arctic Silver Inc., Visalia, Calif.), and 0.01 year for polyol ester liquid without antioxidants. In addition, the paste with carbon black as the solid component has a lower thermal cracking tendency than the paste with boron nitride, fumed zinc oxide or fumed alumina as the solid component.

PCMs with high thermal stability and high heat of fusion, good phase change cyclability and sufficiently low supercooling have been attained by using antioxidants mainly in the form of hydrocarbons with linear segments, specifically a secondary antioxidant, as the phase change component. Said secondary antioxidant is a solid below its melting temperature. This implies that said secondary antioxidant is not dissolved in a liquid solvent (such as polyol ester). The heat of fusion is much higher than those of commercial PCMs. The thermal stability is superior. The use of 98.0 wt. % thiopropionate antioxidant (secondary antioxidant) with 2.0 wt. % half-hindered phenolic antioxidant (primary antioxidant) as the matrix and the use of 16 vol. % boron nitride particles as the solid component (that does not melt while the phase change component melts) give PCM with a 100° C. lifetime indicator of 5.3 years, in contrast to 0.95 year or less for the commercial PCMs. Upon heating at 150° C., these antioxidant-based PCMs degrade in terms of their phase change properties much less than the commercial PCMs. The stability of the heat of fusion upon phase change cycling is also superior.

As TIMs, the antioxidant-based PCMs (above the melting temperature of the phase change component) of this invention give slightly higher values of the thermal contact conductance than commercial PCMs (also above the melting temperature of the phase change component), in spite of the higher values of the bond-line thickness. The effectiveness of PCMs as TIMs is much greater above the melting temperature of the phase change component than below this melting temperature, because the molten phase allows conformability of the TIM with the proximate surfaces that constitute the thermal contact to be enhanced.

A TIM involving a PCM includes a second solid that is in solid state above the melting temperature of the phase change component. Said second solid serves to avoid excessive fluidity of the TIM above the melting temperature of the phase change component. Said second solid is preferably thermally conductive, for the purpose of increasing the thermal conductivity of the TIM both below and above the melting temperature of the phase change component. The thermal conductivity of the TIM above the melting temperature of the phase change component is particularly important for the effectiveness of the TIM for improving thermal contacts.

Examples 1-13 below address the effect of the solid component on the function of antioxidants in the presence of polyol ester, provide a comparative evaluation of various antioxidants and various antioxidant combinations in their effectiveness in improving the thermal stability of polyol-ester-based pastes, and compare the performance of the polyol-ester-based pastes with commercial products. The comparative evaluation addresses various antioxidants and antioxidant combinations, including primary and secondary antioxidants, at various concentrations, with and without a solid component. The primary antioxidants addressed are hindered phenolic compounds. The secondary antioxidant addressed is a thiopropionate compound.

Examples 14-26 below address the use of antioxidants in the absence of liquid solvents (such as polyol ester) for attaining PCMs that satisfy the phase change and thermal stability requirements of electronic applications. In addition, they provide a comparative study of paraffin wax, antioxidant-based PCMs and commercial PCMs. The antioxidant in the antioxidant-based PCMs is primarily a thiopropionate compound, which is a secondary antioxidant.

The TIM performance evaluation described in any of the examples below involves comparative evaluation of TIMs of various compositions. The testing involves thermal contact conductance measurement under various identical conditions. The conditions include the testing method (the guarded hot plate method of thermal contact conductance measurement), the composition (copper) and roughness (15 μm) of the adjoining surfaces, the pressure (0.46, 0.69 and 0.92 MPa) applied to the thermal contact in the direction perpendicular to the plane of the interface and the composition (e.g., boron nitride, carbon black, etc.), volume fraction (4%, unless noted otherwise) of the filler, and the temperature and time of prior heating. This comparative evaluation is supplemented by (i) thermal gravimetric analysis (TGA) for studying the thermal stability at elevated temperatures, (ii) differential scanning calorimetry (DSC) for studying the melting and solidification behavior, and (iii) measurement of the viscosity of the molten state.

Hexagonal boron nitride (BN) is the main filler used in the examples below because of its combination of high thermal conductivity and high electrical resistivity. Carbon black (CB) is a secondary filler used because of its exceptional conformability, which is a consequence of its being in the form of porous agglomerates of nanoparticles. Due to its conformability, carbon black is even more effective as a filler in thermal pastes than highly conductive fillers when the mating surfaces are sufficiently smooth (such as 0.05 μm)

### EXAMPLES

### Example 1

### Materials Used in Formulating Pastes with Polyol Ester as the Vehicle

The polyol esters in this work are pentaerythritol ester of linear and branched fatty acids and dipentaerythritol ester of linear and branched fatty acids. An example is dipentaerythritol hexaester. The polyol ester mixture (HATCOL 2372) is provided by Hatco Corp., Fords, N.J. The specific gravity is 0.97. Evaporation loss is 2% after heating for 6.5 hours at 204° C.

The various antioxidants used in this work are listed in Tables 1 and 2. They include primary and secondary antioxidants.

A primary antioxidant used in this work is 1,3,5-trimethyl-2,4,6-tris (3,5-di-tert-butyl-4-hydroxybenzyl)benzene. It is a fully-hindered phenolic compound and is a commercial product (ETHANOX 330, Albemarle Corp., Baton Rouge, La.) in the form of a powder with melting point 244° C. and molecular weight 775.2 amu. Another primary antioxidant used in this work is 2,2′-methylenebis(4-methyl-6-tert-butylphenol). It is a fully-hindered phenolic compound and is a commercial product (CYANOX 2246, Cytec Industries Inc., West Paterson, N.J.) in the form of a powder with melting point 120-132° C. and molecular weight 340.5 amu.

Another primary antioxidant used in this work is 1,3,5-tris(4-tert-butyl-3-hydroxy-2,6-dimethyl benzyl)-1,3,5-triazine-2,4,6-(1H,3H,5H)-trione. It is a half-hindered phenolic compound and is a commercial product (CYANOX 1790, Cytec Industries Inc.) in the form of a powder with melting point 159-162° C. and molecular weight 699 amu.

Yet another primary antioxidant used in this work is 4,4′-thiobis(2-tert-butyl-5-methylphenol). It is a half-hindered phenolic compound and is a commercial product (SUMILIZER WX-R, Sumitomo Chemical Corp.) in the form of a powder with melting point>160° C. and molecular weight 359 amu.

Still another primary antioxidant used in this work is 3,9-bis[2-[3-(3-tert-butyl-4-hydroxy-5-methylphenyl)-propionyloxy]-1,1-dimethylethyl]2,4,8,10-tetraoxaspiro-[5.5] undecane. It is a half-hindered phenolic compound and is a commercial product (SUMILIZER GA-80, Sumitomo Chemical Corp.) in the form of a powder with melting point>110° C. and molecular weight 741 amu.

A secondary antioxidant used in this work is pentaerythrityl tetrakis-(3-dodecylthiopropionate). It is a thiopropionate and is a commercial product (SUMILIZER TP-D, Sumitomo Chemical Corp.) in the form of flakes with melting point>46° C. and molecular weight 1162 amu.

A propionate ion is C₂H₅COO⁻ (i.e., propionic acid minus one hydrogen ion). A propionate compound is a salt or ester of propionic acid, which is

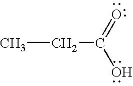

The ketone group (C═O) in thiopropionate enhances the synergistic effect due to the hydrogen bonding with the phenolic antioxidant. The one or more sulfur atoms in thiopropionate serve as the active sites for the antioxidant effect (i.e., the conversion of ROOH to ROH).

Thermal stability is necessary, so that the poly-ester-based paste retains its fluidity and remains in a sufficient quantity at elevated temperatures. An antioxidant with a low molecular weight tends to have high mobility, thereby allowing it to have a greater chance of approaching the radicals that result from the decomposed polyol ester molecules. In addition, an antioxidant that is itself thermally stable is preferred.

TABLE 1
Properties of each antioxidant.

| | Weight | | | |
|---|---|---|---|---|
| | loss onset | Molecular | Melting | |
| Name of | temperature | weight | point | Steric |
| antioxidant | (° C.)^{b} | (g/mol) | (° C.) | hindrance |
| ETHANOX 330 | / | 775 | 244 | Fully-hindered |
| CYANOX 2246^{a} | 267 | 341 | 120-132 | Fully-hindered |
| SUMILIZER GA-80 | 401 | 741 | >110 | Half-hindered |
| SUMILIZER WX-R | 305 | 359 | >160 | Half-hindered |
| CYANOX 1790 | / | 699 | 159-162 | Half-hindered |
| SUMILIZER TP-D | 361 | 1162 | >46 | / |

^{a}CYANOX 2246 has the same molecular structure as SUMILIZER MDP-S, but it is from a different supplier.
^{b}Onset defined as the point of 15% weight loss. Heating rate is 20° C./min. The atmosphere is nitrogen. (Sumitomo Chemical Co. (2006) Product information, http://www.sumitomo-chem.co.jp/kaseihin/2product_data/2_11sumilizer.html, as on Jul. 27, 2006.

Table 1 shows the molecular weight and thermal stability of each of the antioxidants mentioned above. The thermal stability is described in terms of the weight loss onset temperature. The combination of low molecular weight and high weight loss onset temperature is desirable. Thus, SUMILIZER WX-R is expected to be particularly effective. In contrast, CYANOX 2246 suffers from a low weight loss onset temperature, in spite of its low molecular weight.

The carbon black is Vulcan XC72R GP-3820 from Cabot Corp., Billerica, Mass. It is a powder with particle size 30 nm, a nitrogen specific surface area 254 m²/g, maximum ash content 0.2%, volatile content 1.07%, and density 1.7-1.9 g/cm³. The carbon black powder is mixed with the polyol ester vehicle by hand stirring to form a uniform paste containing 2.40 vol. % carbon black (C.-K. Leong and D. D. L. Chung, Carbon 41 (2003) 2459-2469, which is hereby incorporated by reference in its entirety). The particle size (30 nm) of the carbon black is much less than those of the metal or ceramic particles used in commercial thermal pastes.

The boron nitride particles were hexagonal boron nitride, equiaxed in shape (as shown by scanning electron microscopy), with size 5-11 μm, surface area 17 m²/g, oxygen content 0.5%, sulfur content <50 ppm, thermal conductivity 280 W/m·K, and specific gravity 2.2, as provided by GE Advanced Ceramics Corporation, Cleveland, Ohio (Polartherm 180). No functional group is present on the basal plane, but functional groups such as OH, BOH, NH and NH₂ groups are present on the edge plane.

The zinc oxide particles were fumed zinc oxide, specifically VP AdNano Z805 from Degussa AG (Hanau, Germany). It is a nanostructured zinc oxide that has been treated by the manufacturer with an octylsilanized hydrophobic surface. The density is 5.6 g/cm³. The zinc oxide content exceeds 99.5%. The carbon content is 0.2-1.0 wt. %. The zinc oxide is a crystalline solid exhibiting the wurtzite structure, just as the naturally occurring mineral zincite. In this crystal structure, the zinc atom is surrounded tetrahedrally by four oxygen atoms. The smallest units of this material, visible with the electron microscope, are the primary particles with size of the order of 100 nm. The primary particles are joined to each other to form aggregates, which further loosely connect to form agglomerates of size up to 1 mm. The BET specific surface area is 20-25 m²/g.

TABLE 2
Names and the chemical structures of antioxidants

| Name | Chemical structure |
|---|---|
| ETHANOX 330 (1,3,5-trimethyl-2,4,6-tris(3,5-di-tert-butyl-4- hydroxybenzyl)benzene) | 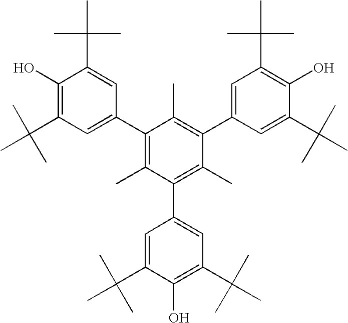 |
| CYANOX 2246 (2,2′-methylenebis(4-methyl-6-tert-butylphenol) | 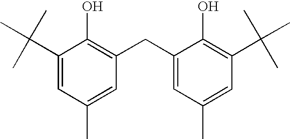 |
| CYANOX 1790 (1,3,5-tris(4-tert-butyl-3-hydroxy-2,6-dimethyl benzyl)-1,3,5-triazine-2,4,6-(1H,3H,5H)-trione) | 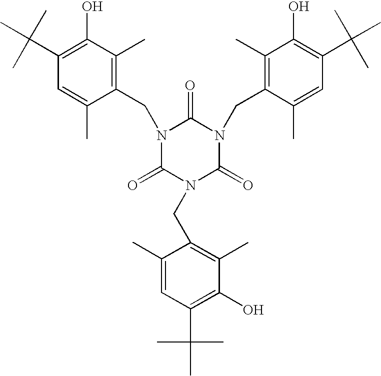 |
| SUMILIZER WX-R (4,4′-thiobis(2-tert-butyl-5-methylphenol)) | 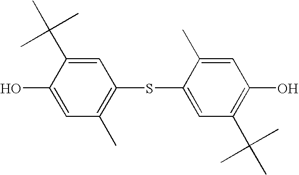 |
| SUMILIZER GA 80 (3,9-bis[2-[3-(3-tert-butyl-4-hydroxy-5- methylphenyl)-propionyloxy]-1,1- dimethylethyl]2,4,8,10-tetraoxaspiro- [5.5]undecane) | 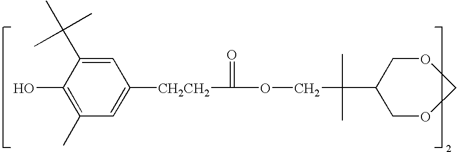 |
| SUMILIZER TP-D (pentaerythrityl tetrakis- (3-dodecylthiopropionate)) | 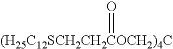 |

The alumina particles were fumed alumina, specifically Aeroxide ALU C805 from Degussa AG (Hanau, Germany). It is aluminum oxide with average particle size 13 nm, density 2.6 g/cm³, BET specific surface area 100±15 m²/g, Al₂O₃ content at least 96 wt. %, and carbon content 3.0-4.5 wt. %.

The solid component in the form of boron nitride, zinc oxide or alumina powder is mixed with the polyol ester vehicle by hand stirring to form a uniform paste containing 16 vol. % solid component.

A number of commercial thermal interface materials were also evaluated in terms of the thermal stability for the sake of comparison. These commercial materials are Arctic Silver® 5 (polyol ester filled with silver particles of the order of 1 μm in size, together with smaller quantities of submicron particles of boron nitride, zinc oxide and aluminum oxide, such that all the conductive solid components together make up 88 wt. % of the paste (Arctic Silver Inc., Visalia, CA), Shin-Etsu X-23-7762 (aluminum particle filled silicone from Shin-Etsu MicroSi, Inc., Phoenix, Ariz.), Thermagon T-pli 210 and T-gon 210 (silicone pads filled with boron nitride particles, with fiberglass reinforcement and thickness 250 μm), Thermagon T-gon 230 (same as T-gon 210 except for a thickness of 760 μm), Dow Corning 340 Heat Sink Compound (zinc oxide filled polydimethylsiloxane), Thermagon T-pcm HP105 (phase change material with phase change softening temperature 50-60° C.), Thermagon T-pcm FSF 52 (phase change material that melts at 52° C.), and Chomerics T454 (phase change material with phase change temperature 43° C. and thickness 130 μm).

### Example 2

### Methods for Testing the Thermal Stability of the Pastes with Polyol Ester as the Vehicle

The fractional loss in mass upon heating is a description of the propensity for thermal instability. A low fractional loss in mass corresponds to a high degree of thermal stability. For measuring the fractional loss in mass, a specimen is heated for a specified amount of time at a selected temperature above room temperature and the mass loss, if any, due to the heating is noted. The temperature is held constant for the heating period, except for the initial short time taken to raise the temperature from room temperature to the selected temperature. In other words, the test is isothermal.

Two methods, both isothermal, are used for testing the extent of mass loss upon heating. One method involves heating the specimen in a thermogravimetric analyzer (TGA), which is a commercial instrument for measuring the mass of a specimen as functions of time and/or temperature. The other method involves heating the specimen in an oven held at a constant temperature and is known as oven-aging testing. The TGA method allows the weight to be constantly monitored, whereas the oven-aging test allows the weight to be measured only before and after the heating.

The isothermal TGA method mentioned above is a conventional method of thermal analysis. It is attractive for detailed kinetic study.

The degree of degradation, α, is defined as the fractional loss in weight due to the heating. It is expressed as

α=(w₀−w)/w₀, (3)

where w₀ is the initial weight of the specimen before heating and w is the actual weight at a point during the heating.

Cracking is observed when a zinc oxide thermal paste is heated at 200° C. for 24 hours, such that the remaining weight is 95.6 wt. % (Table 3). This suggests that a weight loss of 4.4% [i.e. (100.0-95.6) %] may reduce the performance of a thermal paste. Therefore, the time for 3.0% weight loss (i.e., a remaining weight of 97.0%) is used in this work as an indicator of the lifetime of the thermal paste.

The isothermal heating time (τ) for attaining a weight loss of 3% is determined for each of several temperatures, namely 120±2, 140±2, 160±2, 180±2, 200±2 and 220±2° C. The time of zero is taken as the time at which temperature just reaches the set isothermal temperature. The time τ is considered as a lifetime indicator. It is not the true lifetime of the paste under use condition. Nevertheless, the determination of τ for various thermal pastes allows comparison of the thermal stability of the pastes.

TABLE 3
Thermal stability of commercial thermal interface materials and
polyol-ester-based pastes of this work, as indicated after heating
at 200° C. for 24 hours.

| | | Cracking |
|---|---|---|
| Material | Residual weight (%) | tendency |
| Carbon black paste of this work^{a,b} | 96.3 ± 0.6 | No |
| Boron nitride paste of this work^{a,b} | 97.5 ± 0.2 | No |
| Zinc oxide paste of this work^{a,b} | 95.6 ± 0.3 | Yes |
| Alumina paste of this work^{a,b} | 92.8 ± 2.0 | Yes |
| Arctic Silver ® 5^{b} | 92.3 ± 0.2 | Yes |
| Shin-Etsumicrosi^{b} | 94.3 ± 0.2 | No |
| Dow Corning 340^{b} | 99.6 ± 0.1 | No |
| T-gon 210^{c} | 99.0 ± 0.0 | No |
| T-gon 230^{c} | 99.1 ± 0.1 | No |
| Thermagon T-pli 210^{c} | 99.0 ± 0.1 | No |
| Thermagon T-pcm HP105^{d} | 73.9 ± 0.4 | No |
| Thermagon T-pcm FSF 52^{d} | 71.9 ± 0.2 | Yes |
| Chomerics T454^{d} | 68.4 ± 0.6 | No |

^{a}Paste containing 0.500 wt. % SUMILIZER GA80 and 1.000 wt. % SUMILIZER TP-D, and one of the solid components in the group: 2.4 vol. % carbon black, 16 vol. % boron nitride, 16 vol. % of fumed zinc oxide, and 16 vol. % of fumed alumina.
^{b}Thermal paste
^{c}Solid
^{d}Phase change material.

The rate of degradation, dα/dt (where t is the time), describes the rate of weight loss. It is expressed as

dα/dt=k(T)f(α), (4)

where k is the temperature-dependent rate constant, T is the temperature in K, and f(α) is a function of α. The rate constant k increases with temperature, following the Arrhenius form, i.e.,

k(T)=Aexp(−E/RT), (5)

where E is the activation energy, A is the pre-exponential factor and R is the gas constant.

Substitution of Eq. (5) into Eq. (4) gives

da/dt=Aexp(−E/RT)f(α). (6)

Integration of Eq. (6) with respect to time gives

g(α)=∫[dα/f(α)]=A [exp(−E/RT)]t. (7)

Rearrangement of Eq. (7) gives

ln t=E/RT+ln [g(α)/A]. (8)

Based on Eq. (8), E can be determined from the slope of the plot of ln t versus 1/T.

The thermal stability is evaluated in this work by two methods, namely (i) oven-aging (weighing before and after isothermal heating in air at 200° C. for 24 h, with the heating and cooling rates being 3.0° C./min), and (ii) isothermal TGA in air (the heating rate being 3.0° C./min prior to the isothermal period). The TGA testing is conducted by using a Perkin-Elmer Corp. (Norwalk, Conn.) TGA 7 system. Both oven-aging and TGA specimens are contained in aluminum pans.

A heat sink used in a computer is typically made of aluminum or copper. The heat spreader that is in contact with the chip is made of nickel-plated copper. Thus, the surfaces in contact with a thermal paste are usually metals. When a polyol ester is oxidized, it generates acid substances, which can react with a metal surface, thereby partly dissolving the metal and forming radicals, thereby degrading the polyol ester. Although different metals are used in practice, aluminum is one of the most common. The use of aluminum pans in the thermal stability testing of this work means that the results reported here are particularly relevant to applications that involve the thermal paste touching an aluminum surface.

In oven-aging testing, each specimen is contained in an aluminum weighing dish (57 mm in diameter and 10 mm in depth, VWR International) and is heated in air in a box furnace (0.004 m³ in volume, without forced convection, Isotemp® Programmable Muffle Furnace, Fisher Scientific Co.) at 200±5° C. for 24 hours. The maximum operation temperature of thermal pastes used in computers is typically around 100° C. The testing temperature of 200° C. was chosen for oven-aging testing in this work, in order to compare rapidly the thermal stability of pastes containing various combinations of antioxidants and solid components. The weight is measured before heating and after the heating by using an electronic balance (Mettler Mont., Mettler-Toledo, Inc.). The specimen weight (excluding the solid component) is 2,000±1 mg. In addition, each specimen is visually inspected for surface cracks after the heating and subsequent cooling. Two specimens of each type are tested. The same over-aging testing method is used for all types of specimen, including the commercial thermal interface materials.

In both oven-aging and TGA testing, the antioxidant (or antioxidant combination) and the vehicle are placed in an aluminum pan and heated at 200° C. for 15 min in order to allow the antioxidant(s) to dissolve in the vehicle. After that, the solid component (either carbon black in the amount of 2.4 vol. %, or boron nitride in the amount of 16 vol. %) is optionally added and the mixture is stirred manually for 10-15 min. These proportions of solid component have been previously used in relation to thermal paste performance evaluation (C.-K. Leong, Y. Aoyagi and D. D. L. Chung, Journal of Electronic Materials 34 (2005) 1336-1341, which is hereby incorporated by reference in its entirety). The specimen weight (excluding the solid component) is 12.0±0.5 mg. Each specimen is contained in an aluminum pan (6.4 mm in diameter and 1.6 mm in depth, Perkin-Elmer Corp.). The aluminum pan used in TGA is much smaller than that used in oven aging. This difference in size contributes to the difference in percentage weight loss between the two cases.

### Example 3

### Method for Testing the Viscosity of the Pastes with Polyol Ester as the Vehicle

The viscosities of thermal pastes are measured by using a rotational viscometer (Brookfield Engineering Laboratories, Inc., Middleboro, Mass., Model LVT Dial-Reading Viscometer, equipped with a Model SSA-18/13R small sample adaptor). The measurement is conducted at room temperature (19.8±0.5° C.) after heating at 200° C. for various lengths of time up to 48 h.

### Example 4

### Method for Testing the Thermal Contact Conductance Across Surfaces that Sandwich a Paste with Polyol Ester as the Vehicle

The thermal contact conductance across surfaces that sandwich a paste (i.e., in the direction perpendicular to the interface) is a measure of the effectiveness of the paste as a thermal interface material. This quantity is to be distinguished from the thermal conductivity within the paste.

Various thermal interface materials are sandwiched between the 1×1 inch (25×25 mm) surfaces of two copper blocks (both 1×1 inch surfaces of each block having a 12 μm or 800 grit roughness, prepared by mechanical polishing. Each copper block has a height of 35 mm.

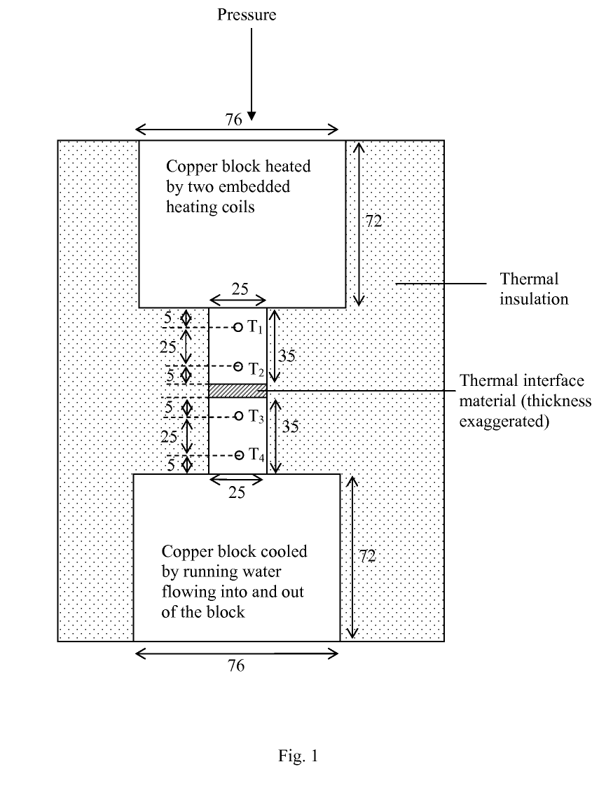

The thermal contact conductance between two 1×1 in (25×25 mm) copper blocks with a thermal interface material between them is measured using the guarded hot plate method, which is a steady-state method of heat flux measurement (ASTM Method D5470). The heat in this test is provided by a 3×3 in (76×76 mm) copper block that has two embedded heating coils (top block in FIG. 1). During the period of temperature rise, the heating rate is controlled at 3.2° C./min by using a temperature controller. This copper block is in contact with one of the 1×1 in copper blocks that sandwich the thermal interface material. The cooling in this test is provided by a second 3×3 in copper block, which is cooled by running water that flows in and out of the block (bottom block in FIG. 1). This block is in contact with the other two 1×1 in copper blocks that sandwich the thermal interface material. A RTD probe (connected to Digi-Sense ThermoLogR RTD (resistance temperature detector) Thermometer from Fisher Scientific Co., with accuracy ±0.03° C.) is inserted in four holes (T₁, T₂, T₃ and T₄ in FIG. 1, each hole of diameter 3.3 mm) one after the other. Two of the four holes are in each of the 1×1 in copper blocks. The temperature gradient is determined from T₁-T₂ and T₃-T₄. These two quantities should be equal at equilibrium, which is attained after holding the temperature of the heater at the desired value for 30 min. Equilibrium is assumed when the temperature variation is within ±0.1° C. in a period of 15 min. At equilibrium, the temperature of the hot block is 100° C., that of the cold block is in the range 12-25° C., while that of the thermal interface material is in the range 50-63° C. The pressure in the direction perpendicular to the plane of the thermal interface is controlled by using a hydraulic press at a pressure of 0.46, 0.69 or 0.92 MPa. The system is thermally insulated by wrapping laterally all the copper blocks with glass fiber cloth.

In accordance with ASTM Method D5470, the heat flow Q is given by

$$Q = \frac{λ A}{{d}_{A}} Δ T , \qquad ( 9 )$$

where ΔT=T₁−T₂=T₃−T₄, X is the thermal conductivity of copper, A is the area of the 1×1 in copper block, and dA is the distance between thermocouples T₁ and T₂ (i.e., 25 mm).

The temperature at the top surface of the thermal interface material is TA, which is given by

$${T}_{A} = {T}_{2} - \frac{d {}_{B}}{d {}_{A}} ( {T}_{1} - {T}_{2} ) , \qquad ( 10 )$$

where d_{B} is the distance between thermocouple T₂ and the top surface of the thermal interface material (i.e., 5 mm). The temperature at the bottom surface of the thermal interface material is T_{D}, which is given by

$${T}_{D} = {T}_{3} - \frac{d {}_{D}}{d {}_{C}} ( {T}_{3} - {T}_{4} ) , \qquad ( 11 )$$

where d_{D} is the distance between thermocouple T₃ and the bottom surface of the thermal interface material (i.e., 5 mm) and dc is the distance between thermocouples T₃ and T₄ (i.e., 25 mm).

The thermal resistivity θ (in unit of m² K/W) is given by

$$θ = ( {T}_{A} - {T}_{D} ) \frac{A}{Q} . \qquad ( 12 )$$

Note that insertion of Eq. (9) into Eq. (12) causes cancellation of the term A, so that θ is independent of A. The thermal contact conductance (in unit of W/(m²·K)) is the reciprocal of θ.

Each type of thermal interface material is tested in terms of the thermal contact conductance for at least twice. Each time involves measurement at three pressures (0.46, 0.69 and 0.92 MPa) in the order listed.

### Example 5

### Results of Thermal Stability Evaluation of Pastes (with Polyol Ester as the Vehicle) by Oven-Aging Testing

The method of oven-aging testing is as described in Example 2. Tables 4-6 show the oven-aging results of the thermal stability evaluation for various combinations of antioxidant(s) and solid component. Table 4 is for the case without any solid component. Table 5 is for the case with carbon black as the solid component. Table 6 is for the case with boron nitride as the solid component. Each of these tables includes the following categories of antioxidant use: (i) use of a primary antioxidant alone at 0.500 wt. %, (ii) use of a secondary antioxidant alone at 0.500 wt. %, (iii) combined use of a primary antioxidant and a secondary antioxidant at a total of 0.500 wt. % (0.167 wt. % of a primary antioxidant and 0.333 wt. % of a secondary antioxidant), and (iv) combined use of a primary antioxidant and a secondary antioxidant at a total of 1.500 wt. % (0.500 wt. % of a primary antioxidant and 1.000 wt. % of a secondary antioxidant). These categories allow comparative evaluation of the effectiveness of various antioxidant species and their proportions.

TABLE 4
Thermal stability of polyol-ester-based liquids in the absence of a solid component, as
indicated by weight loss measurement (200° C. for 24 hours).

| | | | Secondary | | |
|---|---|---|---|---|---|
| | | | antioxidant | | Calculated |
| | Total | | SUMILIZER | Residual | residual |
| Line | antioxidant | | TP-D | weight | weight |
| No. | content (wt. %) | Primary antioxidant | (wt. %) | (%) | (%)^{a} |
| 1 | 0 | / | / | 35.9 ± 2.5 | / |
| 2 | 0.500 | 0.500 wt. % ETHANOX 330 | / | 40.3 ± 0.8 | / |
| 3 | 0.500 | 0.500 wt. % CYANOX 2246 | / | 41.7 ± 2.3 | / |
| 4 | 0.500 | 0.500 wt. % SUMILIZER GA80 | / | 40.9 ± 2.5 | / |
| 5 | 0.500 | 0.500 wt. % SUMILIZER WX-R | / | 58.0 ± 0.5 | / |
| 6 | 0.500 | 0.500 wt. % CYANOX 1790 | / | 46.7 ± 1.8 | / |
| 7 | 0.500 | / | 0.500 | 47.6 ± 0.3 | / |
| 8 | 0.500 | 0.167 wt. % ETHANOX 330 | 0.333 | 51.1 ± 4.6 | 45.2 |
| 9 | 0.500 | 0.167 wt. % CYANOX 2246 | 0.333 | 47.5 ± 1.5 | 45.6 |
| 10 | 0.500 | 0.167 wt. % SUMILIZER GA80 | 0.333 | 97.6 ± 0.1 | 45.4 |
| 11 | 0.500 | 0.167 wt. % SUMILIZER WX-R | 0.333 | 96.3 ± 0.9 | 51.1 |
| 12 | 0.500 | 0.167 wt. % CYANOX 1790 | 0.333 | 97.5 ± 0.1 | 47.3 |
| 13 | 1.500 | 0.500 wt. % ETHANOX 330 | 1.000 | 97.0 ± 0.2 | / |
| 14 | 1.500 | 0.500 wt. % CYANOX 2246 | 1.000 | 69.5 ± 3.7 | / |
| 15 | 1.500 | 0.500 wt. % SUMILIZER GA80 | 1.000 | 97.7 ± 0.2 | / |
| 16 | 1.500 | 0.500 wt. % SUMILIZER WX-R | 1.000 | 97.2 ± 0.0 | / |
| 17 | 1.500 | 0.500 wt. % CYANOX 1790 | 1.000 | 97.4 ± 0.2 | / |

^{a}Calculated residual weight (wt. %) using measured values in Lines 2-7 and the antioxidant proportions in Lines 8-12.

TABLE 5
Thermal stability of polyol-ester-based pastes in the presence of carbon black (the solid
component), as indicated by weight loss measurement (200° C. for 24 hours).

| | Total | | | | | | |
|---|---|---|---|---|---|---|---|
| | antioxidant | | Secondary | Residual weight (%) | | Calculated | |
| | content in | | antioxidant | Excluding | Including | residual | Cracking |
| Line | vehicle | | SUMILIZER | the solid | the solid | weight | after |
| No. | (wt. %) | Primary antioxidant | TP-D (wt. %) | component | component | (%)^{a} | heating |
| 1 | 0 | / | / | 44.5 ± 0.8 | 47.0 ± 0.7 | / | Yes |
| 2 | 0.500 | 0.500 wt. % | / | 55.4 ± 0.3 | 57.3 ± 0.3 | / | Yes |
| | | ETHANOX 330 | | | | | |
| 3 | 0.500 | 0.500 wt. % | / | 52.4 ± 2.1 | 54.5 ± 2.0 | / | Yes |
| | | CYANOX 2246 | | | | | |
| 4 | 0.500 | 0.500 wt. % | / | 56.9 ± 1.0 | 58.8 ± 0.9 | / | Yes |
| | | SUMILIZER GA80 | | | | | |
| 5 | 0.500 | 0.500 wt. % | / | 70.3 ± 2.0 | 71.6 ± 1.9 | / | No |
| | | SUMILIZER WX-R | | | | | |
| 6 | 0.500 | 0.500 wt. % | / | 58.6 ± 0.7 | 60.4 ± 0.7 | / | No |
| | | CYANOX 1790 | | | | | |
| 7 | 0.500 | / | 0.500 | 60.1 ± 2.9 | 61.8 ± 2.8 | / | No |
| 8 | 0.500 | 0.167 wt. % | 0.333 | 53.0 ± 4.1 | 55.1 ± 3.9 | 58.5 | Yes |
| | | ETHANOX 330 | | | | | |
| 9 | 0.500 | 0.167 wt. % | 0.333 | 53.0 ± 4.2 | 55.1 ± 4.0 | 57.5 | Yes |
| | | CYANOX 2246 | | | | | |
| 10 | 0.500 | 0.167 wt. % | 0.333 | 54.8 ± 5.7 | 56.8 ± 5.4 | 59.0 | Yes |
| | | SUMILIZER GA80 | | | | | |
| 11 | 0.500 | 0.167 wt. % | 0.333 | 66.6 ± 6.5 | 68.0 ± 6.2 | 63.5 | No |
| | | SUMILIZER WX-R | | | | | |
| 12 | 0.500 | 0.167 wt. % | 0.333 | 55.7 ± 0.6 | 57.7 ± 0.6 | 59.6 | Yes |
| | | CYANOX 1790 | | | | | |
| 13 | 1.500 | 0.500 wt. % | 1.000 | 92.3 ± 1.4 | 92.6 ± 1.3 | / | No |
| | | ETHANOX 330 | | | | | |
| 14 | 1.500 | 0.500 wt. % | 1.000 | 71.9 ± 1.8 | 73.1 ± 1.7 | / | No |
| | | CYANOX 2246 | | | | | |
| 15 | 1.500 | 0.500 wt. % | 1.000 | 96.1 ± 0.6 | 96.3 ± 0.6 | / | No |
| | | SUMILIZER GA80 | | | | | |
| 16 | 1.500 | 0.500 wt. % | 1.000 | 95.5 ± 0.3 | 95.7 ± 0.3 | / | No |
| | | SUMILIZER WX-R | | | | | |
| 17 | 1.500 | 0.500 wt. % | 1.000 | 90.2 ± 3.1 | 90.6 ± 3.0 | / | No |
| | | CYANOX 1790 | | | | | |

*Calculated residual weight (wt. %) using measured values in Lines 2-7 and the antioxidant proportions in Lines 8-12.

TABLE 6
Thermal stability of polyol-ester-based pastes in the presence of boron nitride (the solid
component), as indicated by weight loss measurement (200° C. for 24 hours).

| | Total | | | | | | |
|---|---|---|---|---|---|---|---|
| | antioxidant | | Secondary | Residual weight (%) | | Calculated | |
| | content in | | antioxidant | Excluding | Including | residual | Cracking |
| Line | vehicle | | SUMILIZER | the solid | the solid | weight | after |
| No. | (wt. %) | Primary antioxidant | TP-D (wt. %) | component | component | (%)^{a} | heating |
| 1 | 0 | / | / | 34.0 ± 0.9 | 51.0 ± 0.6 | / | Yes |
| 2 | 0.500 | 0.500 wt. % | / | 47.3 ± 1.0 | 63.3 ± 0.7 | / | Yes |
| | | ETHANOX 330 | | | | | |
| 3 | 0.500 | 0.500 wt. % | / | 47.4 ± 0.6 | 63.3 ± 0.4 | / | Yes |
| | | CYANOX 2246 | | | | | |
| 4 | 0.500 | 0.500 wt. % | / | 48.8 ± 2.9 | 64.3 ± 2.0 | / | Yes |
| | | SUMILIZER GA80 | | | | | |
| 5 | 0.500 | 0.500 wt. % | / | 60.6 ± 1.6 | 72.5 ± 1.1 | / | No |
| | | SUMILIZER WX-R | | | | | |
| 6 | 0.500 | 0.500 wt. % | / | 48.0 ± 0.5 | 63.8 ± 0.4 | / | Yes |
| | | CYANOX 1790 | | | | | |
| 7 | 0.500 | / | 0.500 | 51.0 ± 0.1 | 65.9 ± 0.1 | / | Yes |
| 8 | 0.500 | 0.167 wt. % | 0.333 | 40.6 ± 7.3 | 58.6 ± 5.0 | 49.8 | Yes |
| | | ETHANOX 330 | | | | | |
| 9 | 0.500 | 0.167 wt. % | 0.333 | 43.3 ± 4.9 | 60.6 ± 3.3 | 49.8 | Yes |
| | | CYANOX 2246 | | | | | |
| 10 | 0.500 | 0.167 wt. % | 0.333 | 41.2 ± 8.1 | 59.1 ± 5.6 | 50.3 | Yes |
| | | SUMILIZER GA80 | | | | | |
| 11 | 0.500 | 0.167 wt. % | 0.333 | 52.6 ± 1.9 | 67.0 ± 1.3 | 54.2 | Yes |
| | | SUMILIZER WX-R | | | | | |
| 12 | 0.500 | 0.167 wt. % | 0.333 | 39.4 ± 1.7 | 59.6 ± 0.9 | 50.0 | Yes |
| | | CYANOX 1790 | | | | | |
| 13 | 1.500 | 0.500 wt. % | 1.000 | 87.6 ± 2.7 | 91.4 ± 1.9 | / | No |
| | | ETHANOX 330 | | | | | |
| 14 | 1.500 | 0.500 wt. % | 1.000 | 63.7 ± 5.6 | 74.8 ± 3.9 | / | No |
| | | CYANOX 2246 | | | | | |
| 15 | 1.500 | 0.500 wt. % | 1.000 | 96.3 ± 0.3 | 97.5 ± 0.2 | / | No |
| | | SUMILIZER GA80 | | | | | |
| 16 | 1.500 | 0.500 wt. % | 1.000 | 95.0 ± 0.2 | 96.5 ± 0.2 | / | No |
| | | SUMILIZER WX-R | | | | | |
| 17 | 1.500 | 0.500 wt. % | 1.000 | 95.6 ± 0.6 | 97.0 ± 0.4 | / | No |
| | | CYANOX 1790 | | | | | |

^{a}Calculated residual weight (wt. %) using measured values in Lines 2-7 and the antioxidant proportions in Lines 8-12

### Example 6

### Effect of Antioxidant on Polyol Ester Liquid in the Absence of a Solid Component

The method of oven-aging testing is as described in Example 2. Comparison of Line 1 and Lines 2-17 of Table 4 shows that all the antioxidants and antioxidant combinations used are effective for improving the thermal stability. Comparison of Lines 2-7 shows that SUMILIZER WX-R is more effective than the other four primary antioxidants or the one secondary antioxidant, all at 0.500 wt. %.

The comparison of the effectiveness of various antioxidant combinations should consider the difference in proportions of the antioxidants in the various combinations. Without any synergistic effect, the remaining weight of Hatcol including two antioxidants and the calculated remaining weight from two remaining weights of Hatcol including different type of single antioxidant in each solution should be equal. However, due to the synergistic effect, the remaining weight of Hatcol including two antioxidants increased the remaining weight.

The proportion of the primary antioxidant in Lines 8-12 is ⅓ of that in Lines 2-7; the proportion of the secondary antioxidant in Lines 8-12 is 2/3 of that in Line 7. If the effectiveness of an antioxidant is proportional to its use proportion, the residual weight for Line 8 is expected to be the sum of 1/3 of that of Line 2 and 2/3 of that of line 7. Hence, the residual weight for Line 8 is expected to be 45.2 wt. %, which is lower than the measured value of 51.1 wt. %. This indicates a synergistic effect of the combined use of ETHANOX 330 and SUMILIZER TP-D. Similar comparison of the calculated and measured residual weights for Lines 8-12 shows similar synergistic effect for each of these antioxidant combinations. The synergistic effect is particularly strong for Lines 10-12, due to the half-hindered structure and high thermal stability (Table 1) of the primary antioxidants for these Lines. In contrast, Lines 8 and 9 involve a primary antioxidant that is fully-hindered and Line 9 involves a primary antioxidant that is relatively low in thermal stability. Therefore, Lines 8 and 9 show less synergistic effect than Lines 10-12.

The superior effectiveness of a half-hindered primary oxidant (SUMILIZER GA-80, SUMILIZER WX-R or CYANOX 1790) in combination with a secondary antioxidant (SUMILIZER TP-D) (i.e., Lines 10-12) means that a half-hindered phenolic primary antioxidant in combination with a thiopropionate type secondary antioxidant is particularly effective for improving the thermal stability. This effectiveness is because of the association between the hydrogen end of the OH group in these three primary antioxidants with the oxygen end of the C═O group in SUMILIZER TP-D. Such intermolecular association will be more difficult if a fully-hindered phenolic compound is used in place of the half-hindered phenolic compound. Due to this association, a primary antioxidant molecule can be very close to a secondary antioxidant molecule. Thus, SUMILIZER TP-D is positioned to decompose the hydroperoxide to the alcohol, as described in Eq. (2), once the hydroperoxide is generated by Eq. (1). In case of a fully-hindered phenolic compound, the intermolecular association is more difficult, thus resulting in a time lag between Eq. (1) and (2). Comparison of Lines 8-12 with Lines 13-17 of Table 4 shows that increase of the total antioxidant proportion from 0.500 to 1.500 wt. % (such that the ratio of primary antioxidant to secondary antioxidant is fixed at 1:2) improves the thermal stability, except for Lines 15-17, where the increase in total antioxidant proportion does not affect the residual weight. That the increase in total antioxidant proportion does not affect the thermal stability for Lines 15-17 is because of the high level of thermal stability already attained at the lower proportion in Lines 10-12 and the inherent volatile content in the vehicle.

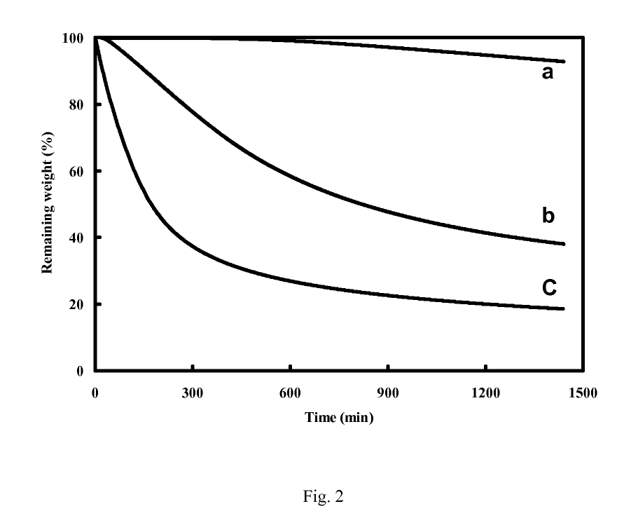

The method of isothermal TGA testing is as described in Example 2. FIG. 2 shows the effect of heating time up to 1,500 min at a fixed temperature (120, 160 or 200° C.) on the remaining weight of polyol ester in the absence of antioxidants, as obtained by TGA. At 200° C., the fractional weight loss is large, but levels off after about 600 min. This leveling suggests the occurrence of cross-linking at 200° C.

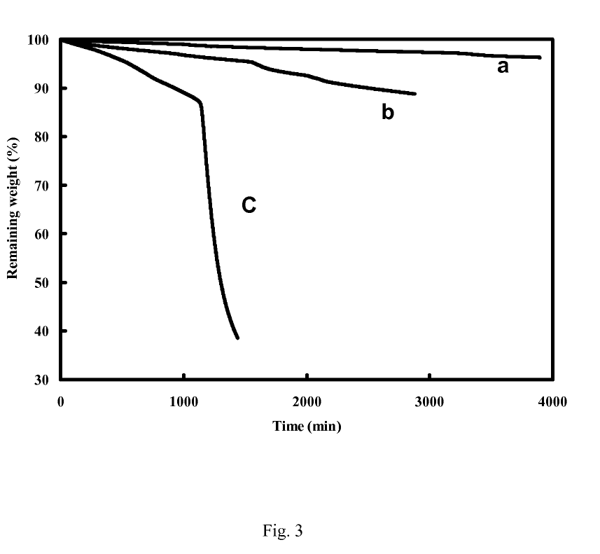

FIG. 3 shows the corresponding results in the presence of antioxidants (0.500 wt. % SUMILIZER GA 80 and 1.000 wt. % SUMILIZER TP-D) for heating at 160, 180 and 199° C. Note the difference in scales between FIGS. 2 and 3. At 160° C., the weight loss is small, even after heating for 4000 min. At 199° C., the weight loss abruptly increases after heating at 1000 min, due to the reaction and consequent loss of function of the antioxidants.

Comparison of FIGS. 2 and 3 shows the effect of antioxidants on the thermal stability. For the essentially same temperature and the same heating time, the weight loss is much lower in the presence of antioxidants. Thus, as expected, the antioxidants enhance the thermal stability.

Comparison of the results from TGA (FIGS. 2 and 3, where 1,440 min is equal to 24 h, which is the time for the oven-aging heating) and those from oven-aging shows similar effect of antioxidants. However, for the same composition, the weight loss is lower for the TGA results than the corresponding oven-aging results. Specifically, in the absence of antioxidant, the remaining weight is 19% from TGA (FIG. 2), but is (35.9±2.5) % from oven-aging (Table 4). In the presence of antioxidants, the remaining weight is 39% from TGA (FIG. 3), but is (97.7±0.2) % from oven aging (Table 4). This difference between TGA and -aging results is attributed to the presence of forced convection in TGA and the absence of forced convection in the furnace.

### Example 7

### Effect of Antioxidant(s) on Pastes with Polyol Ester as the Vehicle and with Carbon Black as the Solid Component

The method of oven-aging testing is as described in Example 2. Comparison of Line 1 of Table 5 with Lines 2-17 of Table 5 shows that any of the antioxidant combinations is effective in the presence of carbon black. This is consistent with the effectiveness in the absence of carbon black, as shown in Table 4.

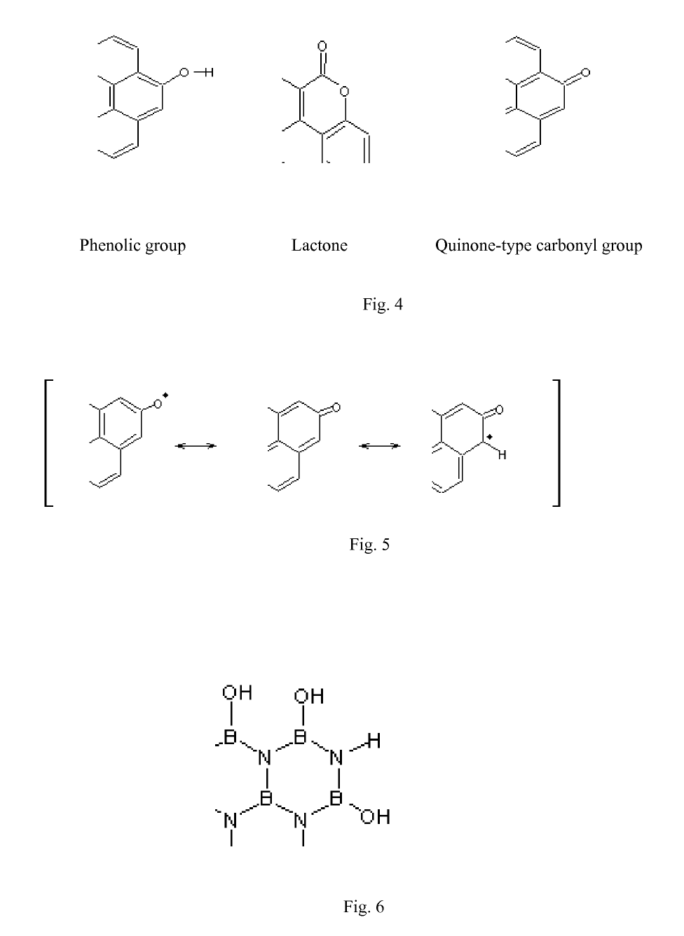

Comparison of Line 1 of Table 4 with Line 1 of Table 5 shows that carbon black improves the thermal stability in the absence of an antioxidant. This is because of the surface functional groups such as phenolic groups on the carbon serving as a primary antioxidant, and quinone and lactone on the carbon serving as a scavenger of alkyl free radicals (FIG. 4). The primary phenolic antioxidant (AH in Eq. (1)) reacts with the peroxy radical (ROO^{•} in Eq. (1)) according to Eq. (1). This reaction rate constant is 3 to 4 times higher than that of Eq. (13). This is due to the stabilization of the antioxidant radical (A^{•} in Eq. (1)) by the resonance effect in the phenolic structure.

RH+ROO^{•}→R^{•}+ROOH (13)

Since carbon black has more aromatic rings than the phenolic antioxidant, the radical on the carbon black is even more stable than that on the antioxidant. Thus, carbon black can act as an antioxidant, the radical of which is even more stable than that of a phenolic antioxidant (FIG. 5). As a consequence, carbon black used as an antioxidant can cause the reaction in Eq. (1) to be even faster than the use of a phenolic antioxidant. Oxidation of organic compounds starts from the generation of alkyl free radicals. Therefore, scavenging alkyl free radicals reduces the amount of peroxide radicals. Carbon black inhibits oxidation, due to the functional groups on the carbon black, as mentioned above, but carbon black can also promote oxidation, due to the adsorption of antioxidants on the carbon black surface.

Comparison of Lines 1-7 of Table 4 with Line 1 of Table 5 shows that carbon black serves as an antioxidants that is superior to the primary antioxidants in Lines 2-4 of Table 4, inferior to the primary antioxidant in Line 5 of Table 4, and similar in effectiveness to the primary antioxidants in Lines 6 and 7 of Table 4.

Comparison of Lines 2-7 of Table 4 with Lines 2-7 of Table 5 shows that carbon black improves the thermal stability in the presence of a single antioxidant. Comparison of Lines 8-17 of Table 4 with Lines 8-17 of Table 5 shows that the addition of carbon black hinders the interaction between primary antioxidant and secondary antioxidant. Since comparison of Lines 2-7 of Table 4 with Lines 2-7 of Table 5 shows that the addition of carbon black improves the thermal stability in the presence of either primary or secondary antioxidant, carbon black does not have antagonistic effect with either antioxidant.

### Example 8

### Effect of Antioxidant(s) with Polyol Ester as the Vehicle and with Boron Nitride as the Solid Component

The method of oven-aging testing is as described in Example 2. Comparison of Line 1 of Table 6 with Lines 2-17 of Table 6 shows that any of the antioxidant combinations is effective in the presence of boron nitride. This is consistence with the effectiveness in the absence of boron nitride, as shown in Tables 4 and 5.

Comparison of Line 1 of Table 4 with Line 1 of Table 6 shows essentially the same residual weight (excluding the solid component). This means that the presence of boron nitride does not improve the thermal stability, in contrast to the improvement in the presence of carbon black (Table 5).

Comparison of Lines 2-7 of Table 4 with Lines 2-7 of Table 6 shows that boron nitride improves the thermal stability for the case of a single antioxidant being used. This means that there is a slight synergetic effect between boron nitride and an antioxidant (primary or secondary). This effect may be due to the NH functional groups at the edge of the basal plane of hexagonal boron nitride (FIG. 6). The radical on the oxygen atom in boron nitride is not stabilized, due to the absence of resonance. Due to the poor stability of the radical, the addition of boron nitride did not show enhancement of the thermal stability (Line 1 of Tables 4 and 6). In other words, boron nitride does not act as a primary antioxidant. However, the NH group on boron nitride may work as an antioxidant.

The hindered amine light stabilizer (HALS) is an additive that is used for enhancing the stability of a polymer against sunlight. HALS has NH group in its structure. Although the reaction rate constant of the NH group with the peroxy radical is smaller than that of the phenolic antioxidant with the peroxy radical, the NH group can trap an alkyl radical. Therefore, although the antioxidant ability of boron nitride itself is not high at 200° C., the combination of boron nitride and a single antioxidant can give rise to a synergistic effect, as shown in Line 1-7 of Tables 4 and 5. The combination of boron nitride and two antioxidants can also have a synergistic effect below 180° C., as shown in Example 10.

However, comparison of Lines 8-17 of Table 4 with Lines 8-17 of Table 6 shows that the presence of boron nitride diminishes the thermal stability when both primary and secondary antioxidants are used. This means that boron nitride hinders the interaction between primary and secondary antioxidants. Since Lines 1-7 of Table 6 in comparison with those of Table 4 indicates that boron nitride has a slight synergistic effect with either primary or secondary antioxidant, boron nitride does not chemically degrade the vehicle. Nevertheless it hinders the interaction between the primary and the secondary antioxidant. This negative effect due to boron nitride is most severe for Lines 10-12 of Table 6. This negative effect is similar, but less severe, when carbon black is present in place of boron nitride, as shown in Table 5, because of the antioxidant function of carbon black (as shown by comparing Line 1 of Tables 4-6). Due to the polarity of the boron nitride surface, the OH group of the primary antioxidant is attracted to the surface of the boron nitride, thereby reducing the amount of primary antioxidant that is available for interacting with the secondary antioxidant. The interaction between the primary and secondary antioxidants is necessary for these antioxidants to be most effective. Although carbon black has a non-polar nature, it has quinone and lactone groups at the edge sites of the carbon layers. These quinone and lactone groups provide electronegative oxygen atoms, which can interact with the OH group of the primary antioxidant, thereby reducing the amount of primary antioxidant that is available for interacting with the secondary antioxidant. However, the amount of quinone and lactone groups on the carbon black is low compared to that of the lone pairs on the nitrogen atoms of boron nitride. As a result, carbon black has a less negative effect on the thermal stability than boron nitride at 200° C. The most effective antioxidant combination when boron nitride is present corresponds to Lines 15-17 of Table 6.

Comparison of Tables 5 and 6 shows that carbon black gives better thermal stability than boron nitride, with the exception of Lines 15-17, for which carbon black and boron nitride give similar performance. The superiority of carbon black may be attributed to the higher stability of radicals on the carbon black (due to the resonance associated with the π electrons).

### Example 9

### Comparison of Polyol-Ester-Based Pastes with Commercial Thermal Interface Materials

This example uses the oven-aging test, as described in Example 2, for comparing the thermal stability of various commercial thermal interface materials. Table 3 shows that commercial thermal interface materials in the form of silicone-based materials (Shin-Etsumicrosi, Dow Corning 340, T-gon 210, T-gon 230 and Thermagon T-pli 210) are among the most thermally stable thermal interface materials tested in this work, with residual weight of 99 wt. % or more. Among these silicone-based materials, Shin-Etsumicrosi is the least stable thermally. The highest residual weight among pastes developed in this work is 96 and 97 wt. % for carbon black and boron nitride pastes respectively (Line 15 of Tables 5 and 6), so the thermal stability attained in this work is almost as high as that of the most thermally stable commercial pastes. In addition, it is superior to Arctic Silver® 5, which also uses polyol esters as its vehicle, and is also superior to Shin-Etsumicrosi, which is based on silicone.

Although the thermal stability of the silicone-based thermal interface materials is higher than those based on polyol esters, the effectiveness as a thermal interface material is inferior, at least for the case of 340 silicone heat sink compound from Dow Corning Corp (Y. Xu, X. Luo and D. D. L. Chung, Journal of Electronic Packaging 122 (2000) 128, which is hereby incorporated by reference in its entirety). Furthermore, polyol ester is typically less expensive than silicone. The phase change materials (the last three rows in Table 3) are among those that are least stable.

### Example 10

### Lifetime Evaluation of Polyol-Ester-Based Pastes Using Thermogravimetric Analysis

The method of isothermal thermogravimetric analysis (TGA) is as described in Example 2. Lifetime evaluation by weight loss measurement in isothermal TGA is conducted for the polyol ester with and without antioxidants (0.500 wt. % of GA80 and 1.000 wt. % of TP-D). For the case with antioxidants, the effect of the solid component (boron nitride or carbon black) is also studied. In addition, similar evaluation is conducted for Arctic Silver® 5.

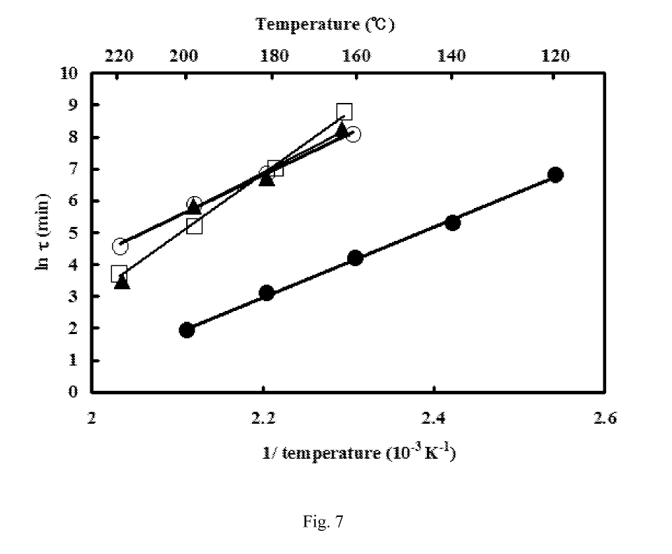

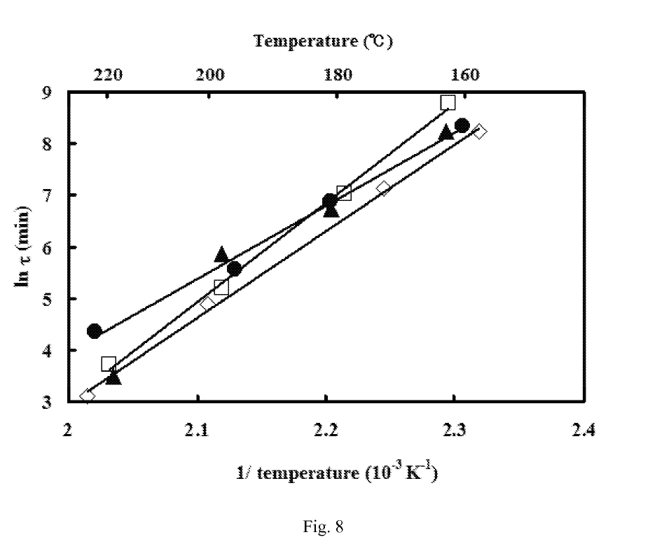

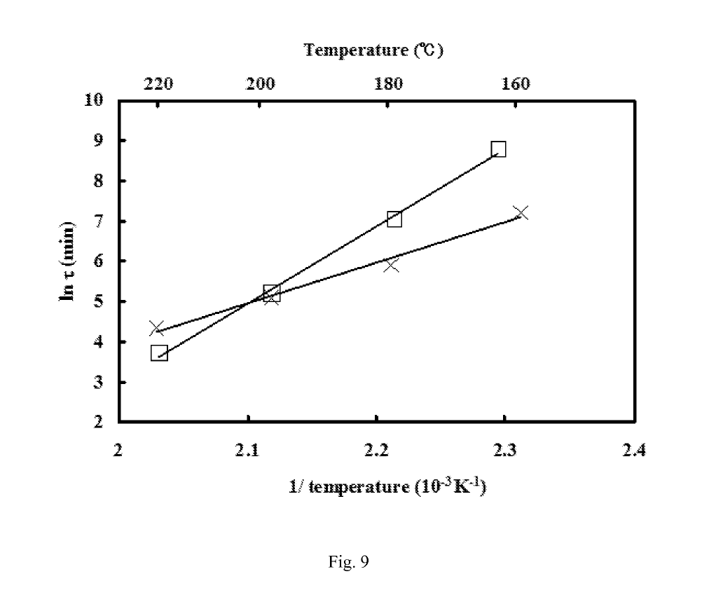

FIGS. 7-9 show the Arrhenius plots of ln τ versus 1/T, where τ is the lifetime indicator. Extrapolation of the plot to a temperature of 100° C. (1/T=2.7×10⁻³ K⁻¹) gives the lifetime indicator for 100° C., which is a typical maximum operation temperature of a thermal paste used in computers. As shown in FIG. 7, for the same temperature, τ is much increased by the presence of the antioxidants. All data points essentially fall on a straight line in FIG. 7-9, except for one data point at the highest temperature for the carbon black paste in FIGS. 7 and 8. In case of the carbon black paste, the exceptional data point is not taken into consideration in determining the activation energy and the lifetime indicator.

The effect of the solid component on τ is small compared to the effect of the antioxidants. Nevertheless, the effect of the solid component is still substantial, due to the logarithmic nature of the vertical scale. In the presence of antioxidants (GA80 and TP-D), the addition of boron nitride reduces the thermal stability above 180° C., but increases the thermal stability below 180° C. (FIG. 7). In the presence of antioxidants, the addition of carbon black reduces the thermal stability at 220° C., but increases the thermal stability below 200° C. At 220° C., both carbon black and boron nitride hinder the synergistic interaction between the two antioxidants. A similar negative effect between the solid component and antioxidants is observed in the 200° C. oven-aging condition (Example 8). Comparison of the various pastes (all containing the same antioxidants) in FIG. 8 shows that, below 180° C., the boron nitride paste is more thermally stable than the carbon black paste, the zinc oxide paste and the alumina paste. This means that, at a typical operating temperature of 100° C., the boron nitride paste is more stable thermally than these other pastes.

Table 7 shows the activation energy for each paste, as obtained from the slopes of the corresponding Arrhenius plot. The activation energy is calculated with the weight of the solid component either included or excluded. For the same formulation, the activation energy is higher (or equal in case of carbon black) when the weight of the solid component is included. However, the activation energy obtained with the weight of the solid component excluded is scientifically more meaningful. The addition of antioxidants (0.500 wt. % of SUMILIZER GA 80 and 1.000 wt. % of TP-D) increases activation energy (Lines 1 and 2 of Table 7 in comparison). The addition of a solid component (boron nitride, alumina nitride, carbon black, alumina or zinc oxide) increases the activation energy (Lines 4-8 in comparison with Line 2). Among the various solid components, boron nitride and aluminum nitride give the greater increase in the activation energy that carbon black, alumina or zinc oxide. This result is consistent with the notion mentioned above concerning the positive effect of the —NH functional group of boron nitride and aluminum nitride on the thermal stability. Arctic silver, on the other hand, shows the lowest activation energy—even lower than that of the polyol ester in the absence of antioxidants.

Table 7 also shows the 100° C. lifetime indicator, as obtained by extrapolation of the curves in FIGS. 7-10. The 100° C. lifetime indicator is calculated with the weight of the solid component either included or excluded. For the same formulation, the 100° C. lifetime indicator is higher (or equal in case of carbon black) when the weight of the solid component is included. However, the 100° C. lifetime indicator obtained with the weight of the solid component excluded is scientifically more meaningful. In all cases with antioxidants, a longer lifetime is associated with a higher activation energy. The longest 100° C. lifetime indicator of 19 years (with the weight of the solid component included) or 3.4 years (with the weight of the solid component excluded) is attained by the boron nitride paste. The next best paste in relation to the 100° C. lifetime indicator is the aluminum nitride paste, which has a lifetime of 13 years (with the weight of the solid component included) or 2.1 years (with the weight of the solid component excluded). However, the aluminum nitride paste is not really a paste, due to extensive separation. The alumina paste and zinc oxide pastes have 100° C. lifetime indicator values of only 1.5 and 3.4 years respectively (with the weight of the solid component included) or 0.61 and 0.40 year respectively (with the weight of the solid component excluded). In the absence of antioxidants, the lifetime is only 0.01 year—even shorter than the lifetime of 0.10 year for Arctic Silver® 5. This comparison shows that the BN paste is the most attractive in terms of the 100° C. lifetime indicator.

Table 7 shows the activation energy for each paste, as obtained from the slope of the lines in FIG. 7-9. The addition of antioxidants (0.500 wt. % of SUMILIZER GA 80 and 1.000 wt. % of TP-D) increases activation energy (Lines 1 and 2). The addition of a solid component (carbon black, fumed alumina, fumed zinc oxide or boron nitride) further increases the activation energy (Lines 2, 3, 5, 7 and 8). When the weight of the solid component is excluded in the activation energy calculation, the activation energy is decreased for the case of boron nitride (Lines 3 and 4), but is not affected for the case of carbon black (Lines 5 and 6). Comparison of Lines 2, 4, and 6 gives the effect of the solid components in the presence of the antioxidants; addition of boron nitride or carbon black increases the activation energy, though the increase is more significant for boron nitride than carbon black. Arctic silver, on the other hand, shows the lowest activation energy—even lower than that of the polyol ester in the absence of antioxidants.

TABLE 7
The 100° C. lifetime indicator and the activation energy for each paste.

| | | E | | 100° C. lifetime | |
|---|---|---|---|---|---|
| | | (kJ/mol) | | indicator (year) | |
| | | Excluding | Including | Excluding | Including |
| Line | | the solid | the solid | the solid | the solid |
| No. | Material | component | component | component | component |
| 1 | Polyol ester | 92 | — | 0.01 | — |
| 2 | Polyol ester with antioxidants* | 106 | — | 0.77 | — |
| 3 | Polyol ester with antioxidants* and boron nitride | 138 | 160 | 3.4 | 19 |
| 4 | Polyol ester with antioxidants* and carbon black | 114 | 114 | 1.3 | 1.3 |
| 5 | Polyol ester with antioxidants* and fumed alumina | 110 | 118 | 0.61 | 1.5 |
| 6 | Polyol ester with antioxidants* and fumed zinc oxide | 113 | 140 | 0.4 | 3.4 |
| 7 | Arctic Silver ® 5 | — | 84 | — | 0.1 |

*Antioxidants: 0.500 wt. % GA 80 and 1.000 wt. % TP-D

In all cases with antioxidants, the longer lifetime is associated with the higher activation energy. The addition of solid component increases the lifetime indicator, though the increase is more significant for boron nitride than other solid components. The longest lifetime of 19 years is obtained for the boron nitride paste. In the absence of antioxidants, the lifetime is only 0.01 year-even shorter than that for Arctic Silver® 5.

### Example 11

### Cracking Tendency of Polyol-Ester-Based Pastes

Information on the cracking tendency is obtained by visual inspection before and after oven-aging testing. The observation of cracks means substantial cracking tendency.

As shown in Table 3, after heating at 200° C. for 24 hours, cracking was not observed for carbon black paste (containing the antioxidants mentioned in Table 3), boron nitride paste (containing the antioxidants mentioned in Table 3) and the commercial aluminum paste (Shin-Etsumicrosi), but was observed for the fumed zinc oxide paste, fumed alumina paste, and the commercial silver paste (Arctic Silver® 5).

The cracking tendency is reduced by the use of antioxidants, as shown for carbon black pastes (Table 5) as well as boron nitride pastes (Table 6). Cracking occurs only for pastes that contain a solid component. Among pastes that contain a solid component, cracking tends to occur when the weight loss after the heating is high. This suggests that the cracking is due to the loss of vehicle during heating.

Carbon black pastes do not show any crack after the heating, which was conducted at 200° C. for 24 hours, except for those with the residual weight (excluding solid component) less than 57 wt. % (Table 5). The boron nitride pastes also do not show any cracking, except for those with the residual weight (excluding solid component) less than 53 wt. % (Table 6). As shown in Table 3, fumed zinc oxide paste and fumed alumina paste show cracking tendency even at high residual weights of 96 and 93 wt. %, respectively. Among pastes that show cracking, the degree of cracking is less for carbon black pastes than boron nitride paste, fumed zinc oxide paste or fumed alumina paste. The lower tendency for cracking for the carbon black pastes compared to the boron nitride, zinc oxide or alumina pastes is due to the lower solid component volume fraction. All of the commercial pastes also do not show cracking, except for Arctic Silver® 5 and Thermagon T-pcm FSF 52. The cracking tendency of Arctic Silver® 5 relates to the high solid content and the limited thermal stability of the vehicle.

### Example 12

### Effect of Heating on the Viscosity of Polyol-Ester-Based Thermal Pastes

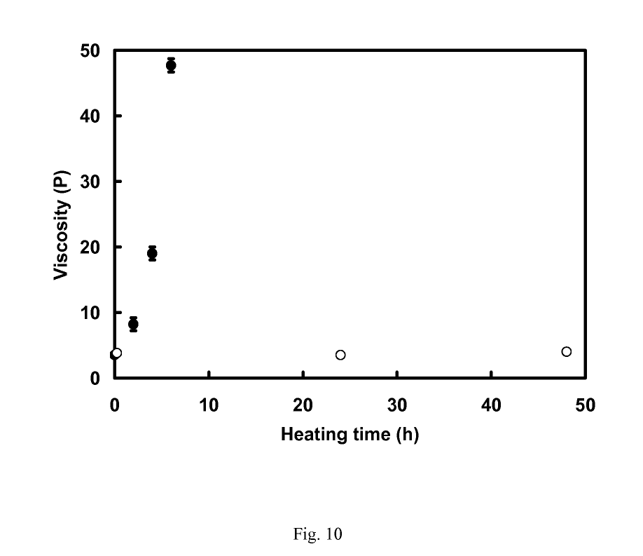

The method of viscosity measurement is as described in Example 3. FIG. 10 shows the effect of prior heating on the room temperature viscosity of thermal pastes without solid components. In the absence of an antioxidant, the viscosity of polyol ester increases significantly after heating at 200° C. for times as short as 2 h. In the presence of antioxidants GA 80 and TP-D, the viscosity essentially does not change, even after heating at 200° C. for 48 h.

The increase in viscosity in the absence of antioxidants suggests the occurrence of crosslinking during heating. This is consistent with the leveling off of the weight loss after 600 minutes of heating at 200° C., as shown in FIG. 2. The cross-linking reduces further evaporation of small decomposed molecules, thereby diminishing further weight loss.

### Example 13

### Thermal Contact Conductance for TIMs in the Form of Polyol-Ester-Based Pastes

TABLE 8
Thermal contact conductance (measured with copper surfaces of 12 μm roughness) of
polyol ester vehicle with and without antioxidant(s).

| | | | Thermal contact conductance | | |
|---|---|---|---|---|---|
| Carbon | Boron | | (10⁴ W/m²° C. | | |
| black | nitride | Antioxidant(s) | 0.46 MPa | 0.69 MPa | 0.92 MPa |
| — | — | — | 10.5 ± 0.6 | 10.7 ± 0.1 | 11.3 ± 0.2 |
| — | — | 0.500 wt. % TPD | 11.0 ± 0.1 | 11.0 ± 0.1 | 11.9 ± 0.2 |
| — | — | 0.500 wt. % GA 80 | 11.1 ± 0.6 | 11.7 ± 0.3 | 11.0 ± 0.1 |
| 2.4 vol. % | — | — | 7.6 ± 0.1 | 8.4 ± 0.2 | 8.7 ± 0.2 |
| 2.4 vol. % | — | 0.500 wt. % GA 80 | 8.4 ± 0.5 | 9.3 ± 0.4 | 9.6 ± 0.0 |
| 2.4 vol. % | — | 1.500 wt. % GA 80 | 8.0 ± 0.1 | 9.2 ± 0.1 | 9.1 ± 0.1 |
| 2.4 vol. % | — | 1.500 wt. % TPD | 9.2 ± 0.1 | 9.8 ± 0.2 | 10.2 ± 0.5 |
| 2.4 vol. % | — | 0.500 wt. % GA 80 + 1.000 wt. % | 7.2 ± 0.4 | 7.7 ± 0.2 | 7.2 ± 0.2 |
| | | TPD | | | |
| — | 16 vol. % | — | 11.6 ± 0.2 | 11.9 ± 0.2 | 12.4 ± 0.2 |
| — | 24 vo1. % | — | 10.8 ± 0.2 | 12.3 ± 0.5 | 12.3 ± 0.2 |
| — | 16 vol. % | 0.500 wt. % GA 80 | 10.0 ± 0.3 | 11.6 ± 0.6 | 11.9 ± 0.1 |
| — | 16 vol. % | 1.500 wt. % TPD | 11.5 ± 0.5 | 12.6 ± 0.2 | 12.9 ± 0.1 |
| — | 16 vol. % | 0.500 wt. % GA 80 + 1.000 wt. % | 10.7 ± 0.3 | 12.0 ± 0.4 | 12.3 ± 0.3 |
| | | TPD | | | |

| | | | | |
|---|---|---|---|---|
| Arctic Silver ® 5 | — | 13.9 ± 0.2 | 14.5 ± 0.3 | 14.6 ± 0.1 |

The method of thermal contact conductance measurement is as described in Example 4. Thermal contact conductance of thermal pastes is shown in Table 8. The presence of antioxidants has negligible effect on the conductance. Although the thermal contact conductance values shown in Table 8 for liquids without a solid component are quite high, the low viscosity (Example 12) and low thermal stability (Table 7) in the absence of a solid component make the liquids without a solid component not practical for use as thermal interface materials. The addition of boron nitride is more effective than carbon black when the copper mating surfaces are rough (15 μm roughness). Arctic Silver® 5 showed high thermal contact conductance, but the thermal stability of this product is low and its cracking tendency is high (Tables 3 and 7).

### Summary of the Results in Examples 5-13

All the antioxidants and antioxidant combinations used are effective for improving the thermal stability, whether a solid component is present or not. In the oven-aging condition (isothermal, 200° C., 24 hours), a synergistic effect occurs when a half-hindered primary antioxidant that has a high thermal stability is used along with a thiopropionate secondary antioxidant. A fully-hindered primary antioxidant is less effective than a half-hindered one. The increment of the total antioxidant proportion from 0.500 to 1.500 wt. % improves the thermal stability, unless a high degree of thermal stability is already attained at 0.500 wt. %. Carbon black and boron nitride as solid components improve the thermal stability for the case of a single antioxidant being used. However, when a primary antioxidant is used along with a secondary antioxidant, the addition of carbon black or boron nitride hinders the synergistic interaction between primary and secondary antioxidants.

In the TGA condition (isothermal) below 180° C. and in the presence of primary and secondary antioxidants, boron nitride enhances the thermal stability, while carbon black has little effect. However, at 220° C. and in the presence of primary and secondary antioxidants, both boron nitride and carbon black hinders the synergistic interaction between the antioxidants and hence degrades the thermal stability. Boron nitride paste shows a 100° C. lifetime indicator of 19 years, compared to 3.4 years for the fumed zinc oxide paste, 1.5 years for the fumed alumina paste, 1.3 years for the carbon black paste, and 0.10 year for Arctic Silver 5.

In consideration of both the oven-aging and TGA results, the following general conclusions can be made. The antioxidants cause the residual weight (excluding the solid component) after heating at 200° C. for 24 hours to increase substantially (from 36 to 97 wt. % for the case of oven aging and from 19 to 39 wt. % for the case of TGA). The antioxidants cause the viscosity not to increase upon heating, in addition to reducing the thermal cracking tendency. They do not affect the thermal contact conductance measured across mating surfaces that sandwich the paste. The use of a fully-hindered phenolic primary antioxidant is less effective. Both carbon black and boron nitride serve as antioxidants in the presence of either primary antioxidant or secondary antioxidant at 200° C., though, in most cases, they degrade the thermal stability in the presence of both primary and secondary antioxidants, particularly at 220° C. Below 180° C. and in the presence of primary and secondary antioxidants, boron nitride is particularly effective in promoting the thermal stability. Fumed zinc oxide and fumed alumina also promote the thermal stability below 160° C., but due to the low activation energy, the lifetime indicator of fumed zinc oxide paste or fumed alumina paste is not as high as that of boron nitride paste.

The thermal stability attained in this work is almost as high as that of the most thermally stable commercial pastes and is superior to Arctic Silver® 5, which also uses polyol esters as its vehicle. Arctic Silver® 5 also suffers from cracking after heating. Cracking after heating was observed for the carbon black pastes corresponding to the residual weight (excluding solid component) below 57 wt. %; it was observed for the boron nitride pastes corresponding to the residual weight (excluding solid component) below 53 wt. %. Fumed zinc oxide paste and fumed alumina paste show cracking tendency even at the high residual weights of 96 and 93 wt. %, respectively.

### Example 14

### Materials for Studies in the Absence of Polyol Ester

TABLE 9
Trade name and molecular structure of each antioxidant
used in studies in the absence of polyol ester.

| Name | Structure |
|---|---|
| SUMILIZER GA 80 | 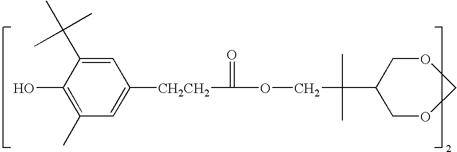 |
| CYANOX 1790 | 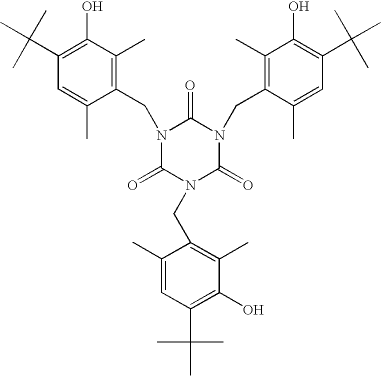 |
| SUMILIZER TP-D | (H₂₅C₁₂SCH₂CH₂COOCH₂)₄C |
| SUMILIZER TPM | (H₂₉C₁₄OOCCH₂CH₂)₂S |
| CYANOX LTDP | (H₂₅C₁₂OOCCH₂CH₂)₂S |

The various antioxidants used in studies in the absence of polyol ester are listed in Table 9. A primary antioxidant used is 3,9-bis[2-[3-(3-tert-butyl-4-hydroxy-5-methylphenyl)-propionyloxy]-1,1-dimethylethyl]2,4,8,10-tetraoxaspiro-[5.5]undecane. It is a half-hindered phenolic compound and is a commercial product (SUMILIZER GA 80, Sumitomo Chemical Corp.) in the form of a powder with melting point>110° C. and molecular weight 741 amu. Weight loss onset temperature (15%) is 401° C. under nitrogen.

Another primary antioxidant used is 1,3,5-tris(4-tertbutyl-3-hydroxy-2,6-dimethyl benzyl)-1,3,5-triazine-2,4,6-(1H,3H,5H)-trione. It is a half-hindered phenolic compound and is a commercial product (CYANOX 1790, Cytec Industries, Inc.) in the form of a powder with melting point 159-162° C. and molecular weight 699 amu.

A secondary antioxidant is pentaerythrityl tetrakis-(3-dodecylthiopropionate). It is a commercial product (SUMILIZER TP-D, Sumitomo Chemical Corp.) in the form of powder with melting point >46° C. and molecular weight 1,162 amu. The purity is 100%. Weight loss onset temperature (5%) is 335° C. under nitrogen.

Another secondary antioxidant is dimyristyl 3,3′-thiodipropionate. It is a commercial product (SUMILIZER TPM, Sumitomo Chemical Corp.) in the form of a powder with melting point 49-54° C. and molecular weight 571 amu. The purity is 100%. Weight loss onset temperature (5%) is 334° C. under nitrogen.

Yet another secondary antioxidant is dilaurylthiodipropionate. It is a commercial product (CYANOX LTDP, Cytec Industries, Inc.) in the form of flakes with melting point 39.5° C. and molecular weight 514 amu.

These antioxidants are chosen for the following reasons. The antioxidant molecules to be used as a PCM should have phase change ability at near 50° C., which requires the molecules to be a hydrocarbon or a related species with linear segments. In order for the molecules to melt at near 50° C. and subsequently align upon cooling with little, if any, supercooling, the segments should not include any bulky side group or heteroatom. Bulky side groups and heteroatoms tend to increase the extent of supercooling, due to the poor alignment of molecules upon solidification. Although aromatic rings in the molecules improve the thermal stability, their presence increases the melting point. Therefore, hydrocarbons with linear segments (e.g., wax, lauric acid, etc.) are often used as PCMs. However, in the absence of appropriate additives, their thermal stability is poor, because of the small molecular size and the low dissociation energy.

In contrast to the conventional use of antioxidants as minor additives to improve the thermal stability of the host, this work uses antioxidants as the matrix medium. This is akin to using the antioxidant as the host. In this context, the antioxidant reacts with radicals formed from some of the antioxidant molecules upon heating, thereby inhibiting the decomposition of the antioxidant. Thiopropionate is an antioxidant that is known for its good thermal stability. SUMILIZER TPM and CYANOX LTDP are thiopropionate antioxidants with linear molecular structures, in contrast to SUMILIZER TP-D (another thiopropionate antioxidant), which has linear segments in a branched molecule. Due to this difference in structure, SUMILIZER TPM and CYANOX LTDP are expected to exhibit little supercooling and high heat of fusion, but poor thermal stability compared to SUMILIZER TP-D.

Paraffin wax (CₙH₂ₙ₊₂, n>20) in the form of a fully refined paraffin wax (CS-2032) from Crystal, Inc.—PMC, Lansdale, Pa., is a powder with purity 100%, specific gravity 0.90, melting point 52-56° C., viscosity (6.7−7.9)×10⁻³ Pa·s at 99° C. and molecular weight exceeding 283 amu.

The carbon black is Vulcan XC72R GP-3820 from Cabot Corp., Billerica, Mass. It is a powder with particle size 30 nm, a nitrogen specific surface area 254 m²/g, maximum ash content 0.2%, volatile content 1.07%, and density 1.7-1.9 g/cm³. The particle size (30 nm) of the carbon black is much less than those of the metal or ceramic particles used in commercial thermal pastes.

The boron nitride particles are hexagonal boron nitride, equiaxed in shape (as shown by scanning electron microscopy), with size 5-11 μm, surface area 17 m²/g, oxygen content 0.5%, sulfur content <50 ppm, thermal conductivity 280 W/m K, and specific gravity 2.2, as provided by GE Advanced Ceramics Corporation, Cleveland, Ohio (Polartherm 180). No functional group is present on the basal plane, but functional groups such as OH, BOH, NH and NH₂ groups are present on the edge plane.

A number of commercial phase change TIMs are also evaluated in terms of the thermal stability and phase change characteristics for the sake of comparison. These commercial materials are Thermagon T-pcm HP 105 (PCM with phase change softening temperature 50-60° C. and thickness 0.005 inch (125 μm) from Laird technologies (St. Louis, Mo.)), Thermagon T-pcm FSF 52 (PCM that melts at 52° C. and thickness 0.005 inch (125 μm) from Laird technologies), Thermagon T-pcm 583 (PCM that melts at 50° C. and thickness 0.003 inch (76 μm) from Laird technologies), and HeatPath PCM 1052 A011 from Tyco Electronics Corporation (Berwyn, Pa.).

### Example 15

### Method of Thermal Stability Testing in the Absence of Polyol Ester

Thermogravimetric analysis (TGA) under isothermal or constant heating rate condition is conducted. The isothermal heating time (T) for attaining a weight loss of 3% is determined for each of several temperatures, namely 120±2, 140±2, 160±2, 180±2, 200±2 and 220±2° C.

In oven-aging testing, each specimen is contained in an aluminum weighing dish (57 mm in diameter and 10 mm in depth, VWR International) and is heated for 24 h in air in a box furnace (0.004 m³ in volume, without forced convection, Isotemp® Programmable Muffle Furnace, Fisher Scientific Co.) at either 150±5° C. or 200±5° C. The maximum operation temperature of thermal pastes used in computers is typically around 100° C. The testing temperature of either 150 or 200° C. is chosen for oven-aging testing in this work, in order to compare rapidly the thermal stability of pastes containing various combinations of antioxidants and solid components. The weight is measured before heating and after the heating by using an electronic balance (Mettler Mont., Mettler-Toledo, Inc.). The specimen weight (excluding the solid component) is 2,000±1 mg, except for the commercial samples. The weight of a commercial sample was 200±25 mg. In addition, each specimen

In both oven-aging and TGA testing, an antioxidant (or an antioxidant combination) or another PCM is placed in an aluminum pan and heated until the solid component in the pan has melted completely. After that, the solid component (either carbon black in the amount ranging from 2.4 to 6.0 vol. %, or boron nitride in the amount ranging from 4.0 to 16 vol. %) is optionally added and the mixture is stirred manually for 10 min. The specimen weight is 12.0±0.5 mg. Each specimen is contained in an aluminum pan (6.4 mm in diameter and 1.6 mm in depth, Perkin-Elmer Corp.). The aluminum pan used in TGA is much smaller than that used in oven aging. This difference in size contributes to the difference in percentage weight loss between the two cases. The cracking tendency of PCMs is studied after heating by visual inspection. Cracking is related to the conformability of the paste. A non-conformable PCM may cause the detachment of the heat sink from the CPU or give rise to more interfacial air, which may reduce the thermal contact conductance.

### Example 16

### Method of Viscosity Testing of Materials Without Polyol Ester

The viscosities of the TIMs in the molten state are measured at 70±0.5° C. by using a rotational viscometer (Brookfield Engineering Laboratories, Inc., Middleboro, Mass., Model LVT Dial-Reading Viscometer, equipped with a Model SSA-18/13R small sample adaptor). The measurement is conducted after heating at 150° C. for various lengths of time up to 72 hours.

### Example 17

### Method of Thermal Contact Conductance Testing of Materials Without Polyol Ester

Each type of TIM is tested in terms of the thermal contact conductance at least twice. Each time involves measurement at three pressures (0.46, 0.69 and 0.92 MPa) in the order listed. The thermal resistance of a system consisting of a thermal paste sandwiched by a heat source and a heat sink can be simply modeled by thermal resistances in series.

R=h/kA+R₁+R₂, (13)

where h is the bond-line thickness, A is the area of the thermal contact, k is the thermal conductivity of the TIM, R is the total thermal resistance of the sandwich, and R₁ and R₂ are the contact resistances of the interface between the TIM and the two surfaces that sandwich the interface material. Eq. (13) means that a higher bond-line thickness will give a higher thermal resistance, i.e., a lower thermal conductance.

### Example 18

### Method of Bond-Line Thickness Measurement

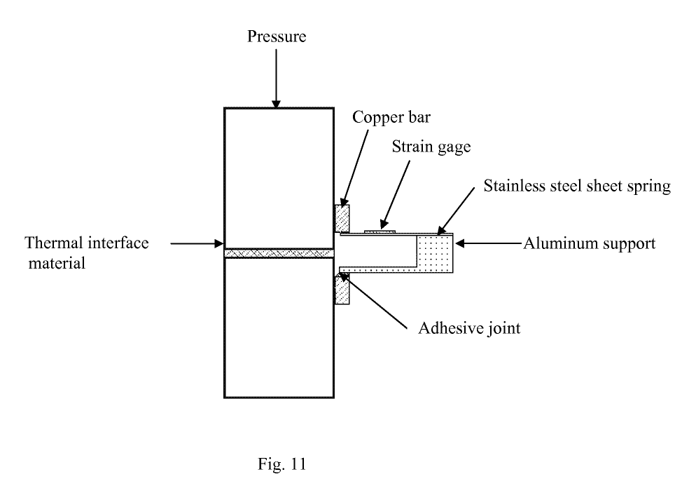

The bond-line thickness refers to the thickness of the TIM. It is measured by sandwiching the thermal paste at a pressure of 0.46 MPa with the rough copper surfaces used for thermal contact conductance measurement. A low value of the bond-line thickness is associated with high spreadability of the thermal paste. A strain gage mounted between the surfaces that sandwich the TIM, as shown in FIG. 11, is used for the bond-line thickness measurement. The strain gage works by sensing the deformation induced by the distance change between the two mating surfaces. The bond-line thickness is calculated from the electrical output of the strain gage. The measurement is conducted at elevated temperature in order to melt the PCMs. The temperature of the hot block is 100° C., while that of the TIM is in the range of 50-69° C.; these temperatures are taken from the temperature T₃ and T₂ of the copper blocks (FIG. 1). First, two copper blocks that are in contact in the absence of an interface material are heated, and the voltage output of the strain gauge is adjusted to 0 mV. After heating the copper blocks for 15 min, a PCM is applied between blocks. After subsequent heating at a pressure of 0.46 MPa for 10 min, the strain gage output is recorded.

### Example 19

### Method of Testing the Phase Change Characteristics

For differential scanning calorimetry (DSC) measurement, a specimen is contained in an aluminum pan and covered by an aluminum lid (without sealing). Testing is conducted in air, using a Perkin-Elmer Corp. (Norwalk, Conn.) DSC 7 system equipped with an ice filled cooler for operation below room temperature. The heating and cooling rates are both 2.0° C./min.

The phase change onset temperature (Tₛ) corresponds to the point of intersection of the tangent (drawn at the point of maximum slope of the leading edge of the DSC peak) and the extrapolated baseline on the same side as the leading edge of the peak. The temperature corresponding to the DSC peak is referred to as Tₚ. Thus, the tangent and the baseline are on the left side of the DSC peak during heating, but they are on the right side of the peak during cooling. The melting and solidification points mentioned in the following sections are both Tₛ. The Tₛ and heat of fusion (ΔH) are calculated by using programs provided by Perkin-Elmer Corp. for this purpose. The supercooling (ΔT) is the temperature difference between Tₛ during heating and Tₛ during cooling for the same thermal cycle. The supercooling is positive if Tₛ during heating is higher than that during cooling, and is negative if Tₛ during heating is lower than that during cooling.

### Example 20

### Method of Testing the Phase Change Cyclability

DSC is used to monitor the phase change cyclability. In the first cycle, the specimen is heated from 30 to 130° C. at a heating rate of 5° C./min and then immediately cooled down from 130 to 30° C. at a cooling rate of 5° C./min. In subsequent cycles, the procedure is identical, except that the temperature is held at the maximum temperature of 130° C. for 100 min.

### Example 21

### Results of Thermal Stability Evaluation of Materials (in the Absence of Polyol Ester) by Oven-Aging Testing

TABLE 10
Thermal stability of various PCMs, as indicated by weight loss measurement after
heating at 150° C. for 24 h (heating rate 3° C./min). BN = boron nitride. CB = carbon black.

| | | Residual weight (%) | | | |
|---|---|---|---|---|---|
| | | Excluding | Including | | |
| | Solid | the solid | the solid | Cracking | Phase |
| Vehicle | component | component | component | tendency | change |
| 2.0 wt. % GA 80 + 98.0 wt. % TP-D | BN 16 vol. % | 99.8 ± 0.0 | 99.9 ± 0.0 | No | Yes |
| 2.0 wt. % GA 80 + 98.0 wt. % TP-D | CB 4.0 vol. % | 99.5 ± 0.1 | 99.5 ± 0.1 | No | Yes |
| 2.0 wt. % GA 80 + 98.0 wt. % TPM | BN 16 vol. % | 97.5 ± 0.0 | 98.3 ± 0.0 | No | Yes |
| 2.0 wt. % GA 80 + 98.0 wt. % TPM | CB 4.0 vol. % | 96.3 ± 0.1 | 96.6 ± 0.1 | No | Yes |
| Paraffin wax | — | 50.7 ± 5.3 | — | No | Yes |
| 2.0 wt. % GA 80 + 48.0 wt. % TP-D + | — | 83.8 ± 2.3 | — | No | Yes |
| 50.0 wt. % wax | | | | | |
| T-pcm 583 | † | — | 97.8 ± 0.2 | No | No^{a} |
| T-pcm HP105 | † | — | 90.9 ± 2.0 | No | No^{a} |
| T-pcm FSF 52 | † | — | 78.2 ± 2.4 | Yes | No^{b} |
| HeatPath PCM 1052 A011 | † | — | 77.7 ± 0.1 | Yes | No^{b} |

† The amounts and types of the solid components are proprietary.
^{a}Softening rather than melting upon heating.
^{b}Remaining solid upon heating.

The thermal stability is tested using the method described in Example 15. Table 10 shows the oven-aging results of the thermal stability evaluation for various PCMs. The degradation of the phase change properties and the weight loss of the material may cause increment of air void content and change of the filler proportion, in addition causing either reduction of the viscosity (pump out problem) or increment of the viscosity (loss of conformability), consequently degrading the performance. Among all the samples tested in this work, the PCM including 2.0 wt. % GA 80, 98.0 wt. % TP-D and boron nitride show the highest thermal stability, as shown by the high residual weight after heating at 150° C. for 24 h. In addition, they retain their ability to change phase after this heating. The addition of the boron nitride enhances the thermal stability more than the addition of carbon black. This is consistent with the result reported in Example concerning the superior thermal stability of polyol-ester-based boron nitride interface material with antioxidant compared to polyol-ester-based carbon black interface material with antioxidant. Surface functional groups (such as the amine group) on boron nitride exhibit a stronger synergistic effect with two antioxidants than the functional groups (such as phenolic and carbonyl groups) on carbon black. The amine group on boron nitride may trap an alkyl radical. In addition, the PCM containing 2.0 wt. % GA 80, 98.0 wt. % TP-D and boron nitride also showed higher thermal stability than the commercial PCMs.

Paraffin wax does not have a high thermal stability, as shown by the low residual weight after heating at 150° C. Even in the presence of antioxidants, which help the thermal stability, the wax remains poor in the thermal stability compared to antioxidant-based PCMs (2.0 wt. % GA 80 plus 98.0 wt. % of either TP-D or TPM). All four commercially available PCMs are less thermally stable than antioxidant-based PCMs containing boron nitride or carbon black.

No crack is observed in antioxidant-based PCMs after the heating, but two commercial PCMs (T-pcm FSF52 and PCM 1052, with residual weight below 78 wt. % after the heating, Table 10) show cracks after the heating. The loss of vehicle upon heating generates cracks when the vehicle has been mixed with a solid component, as reported in Example 5. A high volume fraction of the solid component enhances the tendency for cracking, though the solid component volume fractions of commercial PCMs are proprietary.

### Example 22

### Results of Lifetime Evaluation

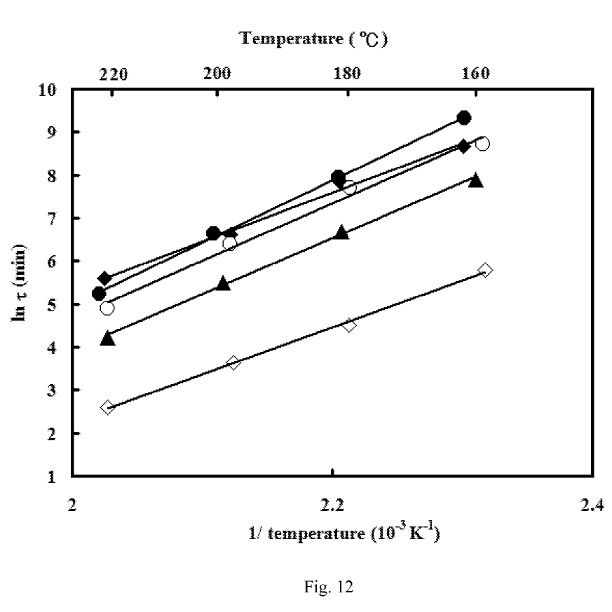

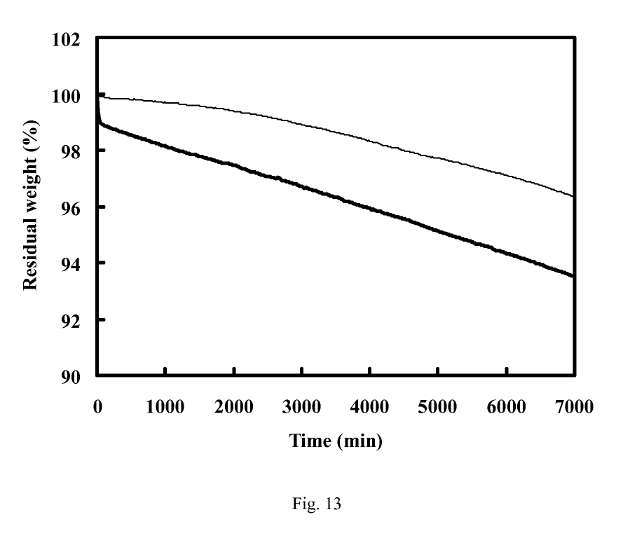

Lifetime evaluation by weight loss measurement in isothermal TGA is conducted for the PCMs. FIG. 12 shows the Arrhenius plots of ln σ versus 1/T, where σ is the lifetime indicator and T is the temperature in K. The commercial PCMs T-pcm 583 and T-pcm HP 105 are chosen for comparison with the antioxidant-based boron nitride PCM, since these commercial PCMs show high thermal stability, as indicated by oven-aging testing at 150° C. for 24 hours (Table 10). Extrapolation of the plot to the temperature of 100° C. (which is outside the horizontal scale in FIG. 12) gives the lifetime indicator for 100° C., which is a typical maximum operation temperature of a thermal paste used in computers. All data points essentially fall on a straight line in FIG. 12. The antioxidant-based PCM containing TP-D, GA 80 and boron nitride is more thermally stable than both of these commercial PCMs. It is superior to T-pcm 583 below 180° C. and is superior to T-pcm HP 105 at all temperatures. This result is consistent with the relative values of the residual weight after heating at 150° C., as shown in Table 10. The thermal stability of the antioxidant combination GA 80 (2.0 wt. %) and TPM (98.0 wt. %) filled with boron nitride was worse than that of T-pcm 583, as shown by the relatively small values of T (FIG. 12). This result is not consistent with that in Table 10, which shows lower thermal stability for T-pcm 583. This difference between Table 10 and FIG. 12 is probably due to the difference in the extent of convection in the two experimental conditions. FIG. 13 shows the residual weight percentage of the antioxidant based PCMs. At the beginning of the isothermal heating, this antioxidant combination filled with boron nitride showed a small degree of abrupt weight loss (FIG. 13). After this initial drop in weight, the residual weight decreases slightly faster than the TP-D based PCM.

The lifetime evaluation is performed by using an open aluminum pan (without a lid). The real situation in microelectronic application is similar to this open situation for the exposed edge of the TIM layer, but is different from this open situation for the part of the TIM that is covered by one or more of the adjoining surfaces. The exposed edge tends to be more severely decomposed than the interior. Therefore, the real lifetime at 100° C. should be longer than the value reported here.

Table 11 shows the activation energy for each PCM, as obtained from the slope of the corresponding curve in FIG. 12. The antioxidant-based PCM (2.0 wt. % of GA 80 and 98.0 wt. % of TP-D, filled with boron nitride) (Line 1, Table 11) shows the highest activation energy among the tested materials. The antioxidant TPM gives lower activation energy, though it is higher than the values for the commercial PCMs. Addition of boron nitride enhances the activation energy. Table 11 also shows the 100° C. lifetime indicator, as obtained by extrapolation of the curves in FIG. 12. A longer lifetime at 100° C. is associated with a higher activation energy, in agreement with the result reported in Example 5, except that the antioxidant TPM exhibits a higher activation energy than the commercial PCM T pcm 583, though it has a shorter lifetime than T pcm 583. The longest lifetime of 5.3 years is attained for the antioxidant-based PCM containing boron nitride. By changing the type of filler from boron nitride to another solid component or by increasing the solid component loading, it may be possible to improve the thermal stability beyond 5.3 years.

TABLE 11
The activation energy (E) and lifetime indicator of each of three PCMs.

| | | E | | 100° C. lifetime | |
|---|---|---|---|---|---|
| | | (kJ/mol) | | indicator (year) | |
| | | Excluding | Including | Excluding | Including |
| Line | | the solid | the solid | the solid | the solid |
| No. | Material | component | component | component | component |
| 1 | 2.0 wt. % GA 80 and 98.0 wt. % TP-D | 118 | 120 | 3.4 | 5.3 |
| | with 16 vol. % BN | | | | |
| 2 | 2.0 wt. % GA 80 and 98.0 wt. % TP-D | 111 | — | 1.7 | — |
| 3 | 2.0 wt. % GA 80 and 98.0 wt. % TPM | 98 | 108 | 0.21 | 0.63 |
| | with 16 vol. % BN | | | | |
| 4 | T pcm 583 | — | 95 | — | 0.95 |
| 5 | T pcm HP 105 | — | 91 | — | 0.1 |

### Example 23

### Results of Viscosity Testing of Materials Without Polyol Ester

TABLE 12
The viscosity (cP) of each of three PCMs at two shear rates.

Shear rate

| Matrix | 16 s⁻¹ | 40 s⁻¹ |
|---|---|---|
| Paraffin wax | 6.5 | 5.9 |
| TP-D | 40 | 41 |
| 98.0 wt. % TP-D + 2.0 wt. % GA 80 | 45 | 43 |

TABLE 13
Comparison of viscosity (cP) after heating at 150° C.
for various lengths of time. (h = hour)

| | Shear rate | | |
|---|---|---|---|
| Matrix | 16 s⁻¹ | 40 s⁻¹ | 79 s⁻¹ |
| Paraffin wax (heated for 1 h) | * | 5.6 ± 0.4 | 6.4 ± 0.0 |
| Paraffin wax (heated for 3 h) | * | 8.1 ± 0.8 | 6.3 ± 0.2 |
| 98.0 wt. % TP-D + 2.0 wt. % GA 80 | 41 ± 0 | 42 ± 1 | 42 ± 0 |
| (heated for 12 h) | | | |
| 98.0 wt. % TP-D + 2.0 wt. % GA 80 | 43 ± 0 | 43 ± 1 | 43 ± 0 |
| (heated for 24 h) | | | |
| 98.0 wt. % TP-D + 2.0 wt. % GA 80 | 42 ± 0 | 43 ± 0 | 44 ± 2 |
| (heated for 3 days) | | | |

* Viscosity is too low to be measured.

The viscosity is measured using the method described in Example 16. Table 12 shows the viscosities at two different shear rates. Paraffin wax has relatively low viscosities, due to their low molecular weights. However, due to the higher molecular weight of TP-D compared to paraffin wax, TP-D shows higher viscosity than wax. Addition of the primary antioxidant GA 80 to TP-D increases the viscosity slightly. Low viscosity may cause the seepage problem. In order to significantly increase the viscosity at the operating temperature, a polymeric antioxidant may be used, but this use is not addressed in this work.

Table 13 shows the effect of heating on the viscosity of PCMs. The effect is small, though it is larger for paraffin wax than the antioxidant PCM. Polyol-ester based pastes reported in Example 5 increased in viscosity upon heating at 200° C., in case antioxidants were not used.

### Example 24

### Thermal Contact Conductance and Bond-Line Thickness

TABLE 14
Thermal contact conductance and bond-line thickness for various PCMs sandwiched
by rough copper surfaces at different pressures.

| | Carbon | Boron | Thermal contact conductance | | | Bond-line |
|---|---|---|---|---|---|---|
| | black | nitride | (10⁴ W/m²° C.) | | | thickness |
| Vehicle | (vol. %) | (vol. %) | 0.46 MPa | 0.69 MPa | 0.92 MPa | (μm) |
| Wax cs-2032¶ | — | — | 9.8 ± 0.5 | 10.4 ± 0.3 | 10.5 ± 0.1 | * |
| Wax cs-2032¶ | 2.4 | — | 5.5 ± 0.1 | 5.8 ± 0.1 | 6.1 ± 0.2 | * |
| Wax cs-2032¶ | — | 4.0 | 7.6 ± 0.2 | 7.7 ± 0.3 | 7.9 ± 0.1 | * |
| TP-D¶ | — | — | 11.8 ± 0.4 | 11.9 ± 0.1 | 12.8 ± 0.4 | * |
| TP-D¶ | 2.4 | — | 5.4 ± 0.3 | 5.6 ± 0.1 | 5.8 ± 0.1 | * |
| TP-D¶ | 4.0 | — | 7.3 ± 0.2 | 8.1 ± 0.2 | 9.2 ± 0.1 | * |
| TP-D¶ | 6.0 | — | 2.0 ± 0.0 | 2.1 ± 0.0 | 2.1 ± 0.0 | * |
| TP-D¶ | — | 4.0 | 8.9 ± 0.4 | 9.4 ± 0.5 | 10.9 ± 0.5 | * |
| TP-D¶ | — | 16 | 11.8 ± 0.3 | 12.4 ± 0.2 | 11.5 ± 0.2 | * |
| 98.0 wt % TP-D + 2.0 wt % GA 80¶ | 4.0 | — | 8.7 ± 0.2 | 10.4 ± 0.1 | 11.1 ± 0.1 | 0.2 ± 0.3 |
| 98.0 wt % TP-D + 2.0 wt % GA 80¶ | — | 16 | 10.6 ± 0.3 | 12.2 ± 0.2 | 12.6 ± 0.2 | 4.3 ± 0.6 |
| T-pcm FSF 52¶ | † | † | 9.1 ± 0.6 | 11.8 ± 0.4 | 11.9 ± 0.5 | * |
| T-pcm 583§ | † | † | 9.1 ± 0.2 | 9.6 ± 0.1 | 10.4 ± 0.1 | 2.7 ± 0.5 |
| T-pcm FSF 52§ | † | † | 8.4 ± 0.0 | 9.4 ± 0.2 | 9.5 ± 0.1 | 1.8 ± 0.3 |

* Not measured.
† The amounts and types of the solid components are proprietary.
¶Conductance measured under condition A of alignment of the copper mating surfaces.
§Conductance measured under condition B of alignment of the copper mating surfaces.

The thermal contact conductance is measured using the method described in Example 17. The bond-line thickness is measured using the method described in Example 18. The thermal contact conductance and bond-line thickness for PCMs sandwiched by rough copper surfaces are shown in Table 14. The thermal contact conductance depends on the volume fraction of solid component, type of solid component, and other factors such as the surface roughness of the copper blocks. At a low volume fraction of the solid component, the particles of the solid component do not contact each other and do not fill the valleys in the surface topography, thus resulting in a low thermal contact conductance. Addition of a high volume fraction of the solid component increases the bond-line thickness, thereby lowering the thermal contact conductance. The dependence of the thermal contact conductance on this volume fraction depends on the type and shape of the solid component. Carbon black and commercial PCMs show lower thermal contact conductance than boron nitride, at least in case of rough surfaces, in spite of the lower values of the bond-line thickness. Although, for the same solid component, a small bond-line thickness helps improve the thermal contact conductance, the boron nitride PCM shows a high thermal contact conductance when the bond-line thickness is substantial. This is presumably due to the high thermal conductivity of the boron nitride.

TABLE 15
Thermal contact conductance for various PCMs sandwiched
by smooth copper surfaces at different pressures.

| | | | Thermal contact | |
|---|---|---|---|---|
| | | | conductance | |
| | Carbon | Boron | (10⁴ W/m² ° C.) | |
| Vehicle | black | nitride | 0.46 MPa | 0.69 MPa |
| 98.0 wt. % TP-D + 2.0 | 4.0 vol. % | — | 11.9 ± 0.2 | 16.1 ± 0.0 |
| wt. % GA 80 | | | | |
| 98.0 wt. % TP-D + 2.0 | — | 16 vol. % | 12.7 ± 0.2 | 14.7 ± 0.1 |
| wt. % GA 80 | | | | |
| T-pcm FSF 52 | † | † | 23.0 ± 1.6 | 24.0 ± 0.5 |
| T-pcm 583 | † | † | 13.6 ± 0.2 | 13.7 ± 0.1 |

† Proportion proprietary

The thermal contact conductance for PCMs sandwiched by smooth copper surfaces is shown in Table 15. T-pcm FSF 52 has a melting point, whereas T-pcm 583 has merely a softening point. This difference suggests that the former can give a lower bond-line thickness. Indeed, the former gives a higher thermal contact conductance. The antioxidant-based boron nitride PCMs give higher thermal contact conductance than the commercial PCMs in case of rough surfaces (Table 14), but they are inferior in case of smooth surfaces (Table 15). The origin of these differences is not completely clear, due to the proprietary nature of the components in the commercial PCMs.

### Example 25

### Phase Change Characteristics

TABLE 16
Phase change properties observed by DSC for PCMs without prior heating. BN = boron nitride. CB = carbon black.

| | Solid | Tₛ (° C.) | | Tₚ (° C.) | | | ΔH (J/g) | |
|---|---|---|---|---|---|---|---|---|
| Phase change material | component | Heating | Cooling | Heating | Cooling | ΔT (° C.) | Heating | Cooling |
| Paraffin wax | — | 47.2 ± 0.1 | 52.8 ± 0.2 | 47.2 ± 0.1 | 52.8 ± 0.2 | −5.6 ± 0.3 | 148 ± 2 | −145 ± 1 |
| Paraffin wax | BN 4.0 vol. % | 47.3 ± 0.1 | 53.4 ± 0.1 | 53.2 ± 0.0 | 51.1 ± 0.1 | −6.1 ± 0.2 | 135 ± 0 | −133 ± 1 |
| Paraffin wax | CB 4.0 vol. % | 47.6 ± 0.3 | 52.7 ± 0.2 | 53.7 ± 0.0 | 50.9 ± 0.0 | −5.1 ± 0.5 | 136 ± 1 | −134 ± 1 |
| LTDP | — | 36.5 ± 0.9 | 34.2 ± 0.2 | 39.9 ± 0.1 | 32.9 ± 0.1 | 2.3 ± 1.1 | 155 ± 2 | −158 ± 2 |
| TPM | — | 45.4 ± 0.4 | 45.9 ± 0.2 | 50.3 ± 0.1 | 44.4 ± 0.2 | −0.4 ± 0.7 | 196 ± 16 | −175 ± 1 |
| 2.0 wt. % GA 80 + 98.0 wt. % TPM | — | 45.6 ± 0.1 | 45.9 ± 0.1 | 50.1 ± 0.1 | 44.3 ± 0.1 | −0.3 ± 0.2 | 177 ± 0 | −173 ± 1 |
| 2.0 wt. % GA 80 + 98.0 wt. % TPM | BN 16 vol. % | 45.8 ± 0.1 | 46.9 ± 0.1 | 49.8 ± 0.1 | 45.9 ± 0.0 | −1.1 ± 0.2 | 120 ± 0 | −116 ± 0 |
| 2.0 wt. % GA 80 + 98.0 wt. % TPM | CB 4.0 vol. % | 45.6 ± 0.1 | 46.1 ± 0.1 | 49.7 ± 0.2 | 44.8 ± 0.0 | −0.5 ± 0.2 | 162 ± 1 | −157 ± 1 |
| TP-D | — | 47.4 ± 0.1 | 42.2 ± 0.1 | 50.0 ± 0.0 | 40.0 ± 0.3 | 5.2 ± 0.2 | 128 ± 0 | −123 ± 1 |
| TP-D | BN 4.0 vol. % | 48.0 ± 0.6 | 46.3 ± 0.2 | 50.3 ± 0.6 | 45.5 ± 0.6 | 1.7 ± 0.8 | 117 ± 1 | −116 ± 0 |
| TP-D | CB 4.0 vol. % | 48.2 ± 0.8 | 44.4 ± 0.2 | 50.3 ± 0.6 | 43.0 ± 0.2 | 3.8 ± 1.0 | 117 ± 2 | −116 ± 1 |
| 2.0 wt. % CYA 1790 + 98.0 wt. % TP-D | — | 45.0 ± 1.1 | 39.0 ± 1.7 | 49.6 ± 0.0 | 34.9 ± 0.4 | 6.0 ± 2.8 | 123 ± 1 | −113 ± 2 |
| 2.0 wt. % GA 80 + 98.0 wt. % TP-D | — | 46.9 ± 0.6 | 42.2 ± 0.8 | 49.7 ± 0.1 | 39.7 ± 1.0 | 4.7 ± 1.4 | 129 ± 0 | −121 ± 2 |
| 5.0 wt. % GA 80 + 95.0 wt. % TP-D | — | 46.0 ± 0.3 | 41.5 ± 0.0 | 49.5 ± 0.2 | 38.9 ± 0.3 | 4.5 ± 0.3 | 126 ± 9 | −117 ± 1 |
| 2.0 wt. % GA 80 + 98.0 wt. % TP-D | BN 16 vol. % | 46.5 ± 0.1 | 46.2 ± 0.2 | 49.3 ± 0.1 | 45.1 ± 0.2 | 0.3 ± 0.3 | 87.1 ± 1.9 | −86.3 ± 0.3 |
| 2.0 wt. % GA 80 + 98.0 wt. % TP-D | CB 4.0 vol. % | 46.6 ± 0.4 | 44.0 ± 0.4 | 49.5 ± 0.3 | 42.8 ± 0.5 | 2.6 ± 0.8 | 115 ± 3 | −113 ± 0 |
| T-pcm FSF 52 | † | 42.4 ± 0.4 | 49.4 ± 0.3 | 50.1 ± 0.1 | 48.3 ± 0.1 | −7.0 ± 0.7 | 29.1 ± 0.4 | −30.6 ± 0.4 |
| HeatPath PCM 1052 A011 | † | 45.6 ± 0.3 | 48.8 ± 0.1 | 51.0 ± 0.2 | 48.2 ± 0.2 | −3.2 ± 0.4 | 29.3 ± 1.5 | −28.6 ± 1.2 |
| T-pcm HP105 | † | — | — | — | — | — | 0 | 0 |
| T-pcm 583 | † | — | — | — | — | — | 0 | 0 |

† Proportion proprietary.

TABLE 17
Phase change properties after heating at 150° C. for 24 h (heating/cooling rate 3° C./min). BN = boron nitride.
CB = carbon black.

| | Solid | Tₛ (° C.) | | Tₚ (° C.) | | | ΔH (J/g) | |
|---|---|---|---|---|---|---|---|---|
| Phase change material | component | Heating | Cooling | Heating | Cooling | ΔT (° C.) | Heating | Cooling |
| Paraffin wax | — | 36.1 ± 3.5 | 44.7 ± 1.3 | 43.8 ± 1.8 | 43.3 ± 0.6 | −8.6 ± 4.8 | 9.5 ± 1.4 | −11.0 ± 2.0 |
| 2.0 wt. % GA 80 + 98.0 wt. % TPM | BN 16 vol. % | 46.9 ± 0.2 | 47.3 ± 0.0 | 50.2 ± 0.0 | 46.2 ± 0.0 | −0.4 ± 0.2 | 127 ± 2 | −123 ± 2 |
| 2.0 wt. % GA 80 + 98.0 wt. % TPM | CB 4.0 vol. % | 46.0 ± 0.1 | 46.1 ± 0.1 | 50.0 ± 0.1 | 44.6 ± 0.0 | −0.1 ± 0.2 | 162 ± 1 | −157 ± 1 |
| 2.0 wt. % GA 80 + 98.0 wt. % TP-D | BN 16 vol. % | 46.3 ± 0.1 | 46.2 ± 0.0 | 49.3 ± 0.1 | 45.2 ± 0.1 | 0.1 ± 0.1 | 85.6 ± 1.2 | −85.6 ± 1.2 |
| 2.0 wt. % GA 80 + 98.0 wt. % TP-D | CB 4.0 vol. % | 41.2 ± 0.1 | 42.1 ± 0.5 | 48.2 ± 0.3 | 39.4 ± 0.2 | −0.9 ± 0.6 | 103 ± 2 | −101 ± 0 |
| T-pcm FSF 52 | † | * | * | * | * | * | 0 | 0 |
| HeatPath PCM 1052 A011 | † | * | * | * | * | * | 0 | 0 |

† Proportion proprietary
* Peak absent

TABLE 18
Phase change properties after heating at 200° C. for 24 h (heating/cooling rate 3° C./min). BN = boron nitride.
CB = carbon black.

| | Solid | Tₛ (° C.) | | Tₚ (° C.) | | | ΔH (J/g) | |
|---|---|---|---|---|---|---|---|---|
| Phase change material | component | Heating | Cooling | Heating | Cooling | ΔT (° C.) | Heating | Cooling |
| 2.0 wt. % GA 80 + 98.0 wt. % of | BN 16 vol. % | 33.1 ± 1.1 | 40.5 ± 0.4 | 41.6 ± 0.6 | 39.1 ± 0.1 | −7.4 ± 1.5 | 33.0 ± 2.5 | −24.7 ± 8.2 |
| TP-D | | | | | | | | |
| 2.0 wt. % GA 80 + 98.0 wt. % | CB 4.0 vol. % | * | * | * | * | * | 0 | 0 |
| of TP-D | | | | | | | | |
| T-pcm FSF 52 | † | * | * | * | * | * | 0 | 0 |

† Proportion proprietary
* Peak absent

The phase change characteristics are measured using the method described in Example 19. Table 16 shows that the various PCMs (with or without a solid component) without any prior heating differ considerably in the supercooling (ΔT) and the heat of fusion (ΔH). The heat of fusion is zero for the commercial PCMs T-pcm HP105 and T-pcm 583, due to the fact that these materials soften rather than melt upon heating (Table 10). Paraffin wax has relatively high melting temperatures. Paraffin wax and the commercial PCMs exhibit less supercooling than the thiopropionate (LTDP, TPM or TP-D). The heat of fusion is relatively high for wax and thiopropionates. The values for TPM and LTDP exceed that of wax (Table 16). The value is particularly high for TPM. However, the value for TP-D is below that of wax (Table 16). The heat of fusion is higher for the antioxidant (TP-D or TPM) based PCMs than the commercial PCMs.

TPM showed the highest heat of fusion and the smallest supercooling among the investigated thiopropionates. In contrast to TPM, TP-D exhibits a branched molecular structure, which may cause reduction of the heat of fusion and increase of the supercooling, due to the less alignment of the branched molecules compared to non-branched molecules. Due to the high heat of fusion of TPM, even in the presence of a solid component, the material still exhibits values of the heat of fusion that are higher than those of the commercial materials.

Although TPM shows higher heat of fusion than TP-D, it is less stable thermally than TP-D. As a consequence, TP-D based PCMs are more attractive for use as TIMs than TPM based PCMs. Addition of a primary antioxidant (GA 80 or CYA 1790) to the secondary antioxidant (TPM or TP-D) did not affect the phase change characteristics, as shown in Table 16.

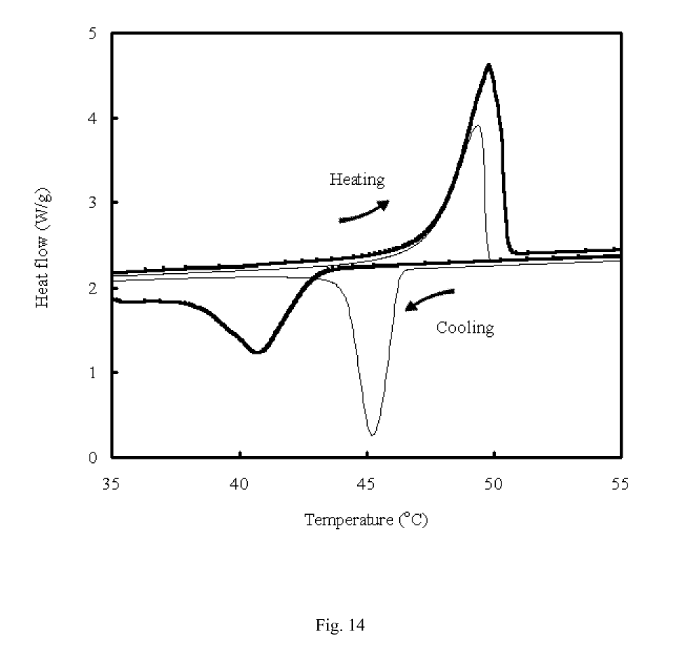

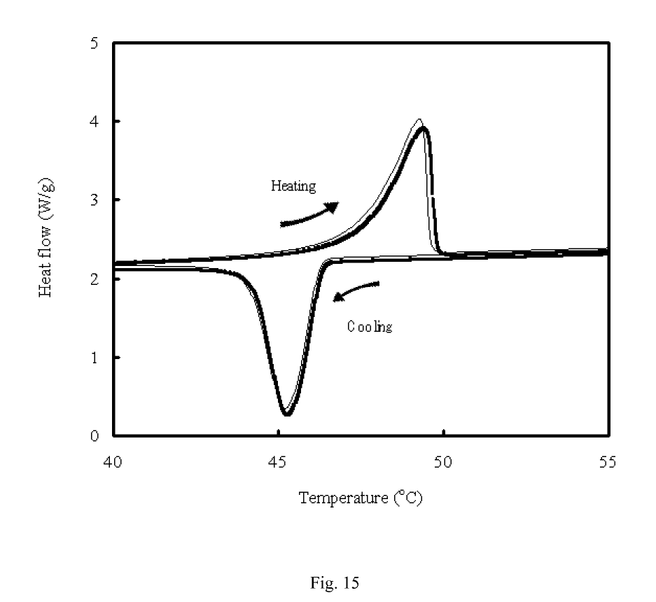

The presence of a solid component tends to diminish the supercooling, except for 4.0 vol. % of carbon black with paraffin wax (Table 16). Boron nitride is more effective than carbon black for diminishing the supercooling, as shown for any of the vehicles tested in this work at the same volume percentage of the solid component. On the other hand, for the same matrix, the heat of fusion showed similar values at the same volume fraction of different solid components (Table 16). FIG. 14 shows DSC curves which compares the antioxidant-based (2.0 wt. % of GA 80, 98.0 wt. % of TP-D) PCM with and without 16 vol. % of boron nitride. Although the heat of fusion is decreased by the presence of BN, the supercooling is reduced by the presence of BN. Boron nitride may work as nuclei of the growing crystal of the phase change matrix.

In the case that PCMs are used as TIMs in microelectronics, the amount of PCMs involved is small. Therefore, the effect of the heat of fusion is not significant. However, the heat of fusion is important when a PCM is used for heat storage, which relates to heat removal from the electronics. The solid component and its composition affect the phase change characteristics. The heat of fusion (latent heat per gram, absorbed during melting) is decreased by the addition of a solid component, since the solid component does not melt and takes up a part of the mass.

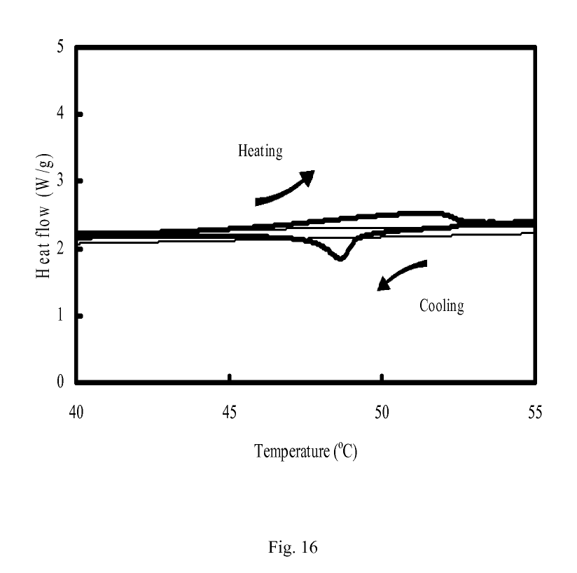

Heating at 150° C. for 24 hours greatly degrades the phase change properties of commercial PCMs (Table 17). This is mainly because of the poor thermal stability of matrices in the commercial PCMs (Table 10). Moreover, this degradation of the phase change properties relates to the change in the chemical structure of the matrices of commercial PCMs upon heating. Although commercial materials T-pcm 583 and T-pcm HP105 show relatively high thermal stability (Table 10), they merely become soft upon heating and do not show the clear phase change behavior. This is probably because of the non-crystalline polymers involved. On the other hand, the antioxidant (98.0% of TP-D and 2.0% of GA 80) based boron nitride PCM shows relatively little effect of heating on the phase change properties (Table 17 and FIG. 15). Even after heating at 200° C. for 24 h (Table 18), it shows clear phase change behavior (Table 17). In contrast, the phase change behavior of the commercial PCMs ceases to exist after heating at 150° C. (Table 17 and FIGS. 15 and 16) or 200° C. (Table 18). The ability of the antioxidant (98.0% of TP-D and 2.0% of GA 80) based boron nitride PCM to retain its phase change behavior after heating relates to the thermal stability of this material (Tables 10 and 11).

### Example 26

### Phase Change Cyclability

TABLE 19
Phase change cyclability of the commercial phase change material
Thermagon T-pcm FSF 52

ΔH (J/g)

| Cycle No. | Heating | Cooling |
|---|---|---|
| 1 | 30 | −33 |
| 2 | 33 | −33 |
| 3 | 33 | −32 |
| 4 | 32 | −30 |
| 5 | 30 | −29 |
| 6 | 27 | −29 |

TABLE 20
Phase change cyclability of the antioxidant phase change
material (98 wt. % TP-D, 2.0 wt. % GA 80, 16 vol. % BN)

ΔH (J/g)

| Cycle No. | Heating | Cooling |
|---|---|---|
| 1 | 88 | −86 |
| 2 | 89 | −86 |
| 3 | 89 | −86 |
| 4 | 88 | −86 |
| 5 | 88 | −86 |
| 6 | 85 | −86 |
| 7 | 90 | −86 |
| 8 | 89 | −86 |
| 9 | 89 | −85 |
| 10 | 88 | −85 |
| 11 | 88 | −85 |

The phase change cyclability is tested using the method described in Example 20. Tables 19 and 20 show the effect of phase change cycling on the heat of fusion for a commercial phase change material (Thermagon T-pcm FSF 52) and an antioxidant-based phase change material (98 wt. % TP-D, 2.0 wt. % GA 80, 16 vol. % BN) respectively. Melting tends to remove the effect of thermal history on the molecular conformation of a PCM, so the values of the heat of fusion (ΔH) obtained during cooling (after melting) are more reliable than those obtained during prior heating. Based on the values obtained during cooling, ΔH is reduced by 12% after 6 cycles for the commercial PCM and is reduced by only 1% after 11 cycles for the antioxidant-based PCM. The superior phase change cyclability of the antioxidant-based PCM is consistent with the results in Tables 17 and 18.

### Summary of the Results in Examples 14-26

Antioxidant-based PCMs, with the antioxidants serving as the matrix and consisting mainly of hydrocarbons with linear segments, are effective as TIMs with high thermal stability. The thermal stability is superior to paraffin wax and commercial PCMs (Laird T-pcm 583, Thermagon T-pcm HP105, Thermagon T-pcm FSF 52 and HeatPath PCM 1052 A011). The combined use of 98.0 wt. % of a thiopropionate secondary antioxidant (SUMILIZER TP-D) and 2.0 wt. % of a half-hindered phenolic primary antioxidant (GA 80) as the matrix and the use of 16 vol. % boron nitride particles as the solid component give a PCM with a 100° C. lifetime indicator of 5.3 years, as shown by thermogravimetric analysis, in contrast to 0.95 year or less for the commercial PCMs. This PCM does not crack after heating at 150° C., in contrast to the cracking for some commercial PCMs. The phase change properties are degraded by heating at 150° C. to much smaller degrees than those of the commercial PCMs. The stability of the heat of fusion upon phase change cycling is also superior.

The heat of fusion of an antioxidant-based PCM is much higher than those of commercial PCMs. A branched antioxidant, TP-D, tends to be slightly lower than that of wax, but non-branched antioxidants, TPM and LTDP, showed values exceeding that of wax. The undercooling of an antioxidant-based PCM is larger than that of wax or those of commercial PCMs, in spite of the decrease of the undercooling by the presence of a solid component. The viscosity of an antioxidant-based PCM is essentially unaffected by heating at 150° C.; it is higher than that of wax. The thermal contact conductance of an antioxidant-based PCM is higher than those for the commercial PCMs in case of rough (12 μm) copper mating surfaces, though it is lower than those for the commercial PCMs in case of smooth (0.009 μm) copper surfaces.

The use of carbon black (4.0 vol. % or less) in place of boron nitride gives slightly lower thermal stability and slightly lower thermal contact conductance for the rough case. The lower thermal contact conductance occurs in spite of the lower bond-line thickness for carbon black.

Compared to the boron nitride antioxidant-based PCM, commercial PCMs give slightly lower values of the thermal contact conductance for the rough case, in spite of the lower values of the bond-line thickness. Commercial PCMs give higher values of the thermal contact conductance for the smooth case, presumably due to the lower values of the bond-line thickness.

Although preferred embodiments have been depicted and described in detail herein, it will be apparent to those skilled in the relevant art that various additions, substitutions, modifications and the like can be made without departing from the spirit of the invention and these are therefore considered to be within the scope of the invention as defined in the claims which follow.

1. A composition comprising first solid and second solid,
wherein the molten form of said first solid exhibits high thermal stability and the melting of said first solid exhibits high heat of fusion,
said first solid consisting essentially of secondary antioxidant,
said second solid being in solid state at use temperatures above the melting temperature of said first solid.

2. A liquid that exhibits high thermal stability, said liquid comprising
(a) polyol ester,
(b) secondary antioxidant dissolved in said polyol ester, and
(c) primary antioxidant dissolved in said polyol ester,
said liquid comprising
(a) said polyol ester,
(b) said secondary antioxidant, and
(c) said primary antioxidant,
being in contact with solid,
said solid selected from the group consisting of: hexagonal boron nitride, carbon black, graphite nanoplatelet, carbon fiber, carbon nanofiber, carbon nanotube, clay, and fumed metal oxide,
said solid enhancing the thermal stability of said liquid comprising
(a) said polyol ester,
(b) said secondary antioxidant, and
(c) said primary antioxidant.

3. A thermal contact enhancing interface material comprising first solid and second solid, the molten form of said first solid exhibiting high thermal stability,
said first solid being in contact with said second solid,
said second solid being dispersed in said first solid,
said second solid being in solid state at use temperatures above the melting temperature of said first solid,
said first solid consisting essentially of secondary antioxidant,
wherein said material, being in contact with and positioned between two solid surfaces, forms a material that enhances the thermal contact between said surfaces at use temperatures above the melting temperature of said first solid.

4. The composition of claim 1, wherein said secondary antioxidant is thioether.

5. The liquid of claim 2, wherein said secondary antioxidant is thioether.

6. The thermal contact enhancing interface material of claim 3, wherein said secondary antioxidant is thioether.

7. The composition of claim 1, wherein said secondary antioxidant is thiopropionate.

8. The liquid of claim 2, wherein said secondary antioxidant is thiopropionate.

9. The thermal contact enhancing interface material of claim 3, wherein said secondary antioxidant is thiopropionate.

10. The liquid of claim 2, wherein said primary antioxidant is half-hindered phenolic compound.

11. The composition of claim 1, wherein said second solid is selected from the group consisting of: boron nitride, aluminum nitride, carbon black, carbon fiber, carbon nanotube, graphite, diamond, alumina, silica, zinc oxide, clay, silver, gold, aluminum, and nickel.

12. The liquid of claim 2, said liquid comprising
(a) polyol ester,
(b) secondary antioxidant dissolved in said polyol ester, and
(c) primary antioxidant dissolved in said polyol ester,
wherein said fumed metal oxide is chosen from the group consisting of: fumed alumina, fumed zinc oxide, fumed silica, fumed titania, fumed zirconia, fumed magnesia, fumed ceria, and fumed germania.

13. The thermal contact enhancing interface material of claim 3, wherein said solid is selected from the group consisting of: boron nitride, aluminum nitride, carbon black, carbon fiber, carbon nanofiber, carbon nanotube, graphite, diamond, alumina, silica, zinc oxide, clay, silver, gold, aluminum, nickel and fumed metal oxide.

14. The liquid of claim 2, said liquid comprising
(a) polyol ester,
(b) secondary antioxidant dissolved in said polyol ester, and
(c) primary antioxidant dissolved in said polyol ester,
wherein the sum of
(a) the amount of said secondary antioxidant, and
(b) the amount of said primary antioxidant,
is less than 5% by weight of said liquid.

15. The composition of claim 1, wherein said first solid further comprises primary antioxidant.

16. The composition of claim 1,
wherein said first solid further comprises primary antioxidant,
wherein the weight ratio of said secondary antioxidant to said primary antioxidant is in the range from 5:1 to 100:1.

17. The thermal contact enhancing interface material of claim 3,
wherein said first solid further comprises primary antioxidant.

18. The thermal contact enhancing interface material of claim 3,
wherein said first solid further comprises primary antioxidant,
wherein the weight ratio of said secondary antioxidant to said primary antioxidant is in the range from 5:1 to 100:1.

19. The composition of claim 1, wherein
said second solid is in the amount ranging from 1% to 60% by volume of said composition.

20. The liquid of claim 2, said liquid comprising
(a) polyol ester,
(b) secondary antioxidant dissolved in said polyol ester, and
(c) primary antioxidant dissolved in said polyol ester,
said solid in contact with said liquid being in the amount ranging from 1% to 60% by volume of the composition consisting of
(i) said solid and
(ii) said liquid comprising
(a) said polyol ester,
(b) said secondary antioxidant, and
(c) said primary antioxidant.
